(19) United States
(12) Patent Application Publication
(10) Pub. No.: US 2017/0083201 A1
(43) Pub. Date: Mar. 23, 2017

(54) METHOD AND SYSTEM FOR NAVIGATION AND SELECTION IN ELECTRONIC DEVICE

(71) Applicant: Samsung Electronics Co., Ltd., Suwon-si (KR)

(72) Inventors: Ankur SHARMA, Bharatpur (IN); Sachin Kumar GUPTA, Aligarh (IN)

(21) Appl. No.: 15/268,982

(22) Filed: Sep. 19, 2016

(30) Foreign Application Priority Data
Sep. 22, 2015 (IN) 3006/DEL/2015

(51) Int. Cl. G06F 3/0486; G06F 17/30; G06F 3/0488; G06F 3/0481; G06F 3/0484

(52) U.S. Cl. CPC G06F 3/0486; G06F 3/04817; G06F 3/04842; G06F 3/04883; G06F 17/30126

(57) ABSTRACT

The embodiments herein provide a method for selecting a data item from a directory in an electronic device. The method comprises detecting a first touch input dragging a a first object for a folder to a predetermined region of a screen of the electronic device, displaying at least one second object for at least one item which is included in the folder on the electronic device based on the first touch input, detecting a second touch input to select one object among the at least one second object, and performing an item corresponding to the selected object.

### PRIORITY

The application claims the benefit under 35 U.S.C. §119(a) of an Indian patent application filed in the Indian Intellectual Property Office on Sep. 22, 2015 and Nov. 9, 2015 and assigned Serial Nos. 3006/DEL/2015(PS) and 3006/DEL/2015(CS), the entire disclosure of which are hereby incorporated by references.

### TECHNICAL FIELD

The embodiments herein generally relate to file navigation systems. More particularly to a mechanism for navigation and selection of a data item in a directory of an electronic device.

### BACKGROUND

Portable electronic devices (such as gaming devices, smart phones, tablets, phablets, media players, digital assistants, electronic book reader devices, consumer electronic devices, or the like) are becoming increasingly popular. With increasing use of electronic devices or intelligent touch or non-touch user interface based computing devices, the organization and navigation of data is becoming a big challenge.

Typically, a user uses a folder structure for storage of the data. The user can organize the data much efficiently using the folder structure. The user can therefore organize applications related to music in one folder; applications related to gaming in other folder, study related content in another folder, or the like. The user can also store all the folders in an organized manner in a main folder, titled as applications. Therefore, a wide variety of options are available for the user to organize the data once the folder structure organization is used. With growing usage of the folder structure organization, the complexity of locating the data inside the folders has increased. The user has to undergo multiple steps or perform multiple gestures to locate a particular file. In case, if the data is more and is organized in multiple hierarchies, the user has to navigate to multiple directories to locate a particular file.

In the conventional systems and methods, such electronic devices usually have a graphical user interface that allows the user to use a mouse to “click” or “double click” an icon on a screen of the electronic device to view contents of the selected icon. For example, if the icon represents the folder, double clicking on the icon causes a new window to be shown on the screen including the constituent folders or files. However, while searching in the multiple folders, the user has to undergo multiple steps to locate the files of interest which can be cumbersome and time consuming.

In another conventional systems and methods, the user needs to manually perform a search activity in the electronic device to locate the files of interest. However, in such systems and methods, the user has to remember and manually input name or part of the name of the file of interest to perform the search activity. Thus, there is a need in the art to provide a robust and simple navigation schemes across the folder structure, more particular, in multi-hierarchal folder structure.

### SUMMARY

The principal object of the embodiments herein is to provide a method for selecting a data item from a directory in an electronic device by performing gestures.

Another object of the embodiments herein is to provide a mechanism for detecting a first gesture performed relative to a first data item displayed on the electronic device, where the first data item constitutes a set of second data items.

Another object of the embodiments herein is to provide a mechanism for causing to display the set of second data items along with the first data item on the electronic device.

Another object of the embodiments herein is to provide a mechanism for detecting a second gesture covering a distance from the first data item.

Another object of the embodiments herein is to provide a mechanism for causing to display selection of at least one second data item from the set of second data items based on the distance.

Yet another object of the embodiments herein is to provide a mechanism for detecting a second gesture performed on the first data item.

Yet another object of the embodiments herein is to provide a mechanism for causing to display a set of third data items constituting at least one of the second data item from the set of second data items.

Accordingly the embodiments herein provide a method for selecting a data item from a directory in an electronic device. The method includes detecting a first gesture performed relative to a first data item displayed on the electronic device, where the first data item constitutes a set of second data items. Further, the method includes causing to display the set of second data items along with the first data item on the electronic device. Further, the method includes detecting a second gesture covering a distance from the first data item. Further, the method includes causing to display selection of at least one second data item from the set of second data items based on the distance.

Accordingly the embodiments herein provide a method for selecting a data item from a directory in an electronic device. The method includes detecting a first gesture performed relative to a first data item displayed on a screen of the electronic device, where the first data item constituting a set of second data items. Further, the method includes causing to display the set of second data items along with the first data item on the screen of the electronic device. Further, the method includes detecting a second gesture performed on the first data item. Further, the method includes causing to display a set of third data items constituting the second data item from the set of second data items.

Accordingly the embodiments herein provide an electronic device for selecting a data item from a directory. The electronic device including a memory unit and a processor unit coupled to the memory unit, where the processor unit is configured with processor executable instructions to detect a first gesture performed relative to a first data item displayed on the electronic device, where the first data item constitutes a set of second data items. Further, the processor unit is configured to cause to display the set of second data items along with the first data item on the electronic device. Further, the processor unit is configured to detect a second gesture covering a distance from the first data item. Further, the processor unit is configured to cause to display selection of at least one second data item from the set of second data items based on the distance.

Accordingly the embodiments herein provide an electronic device for selecting a data item from a directory. The electronic device including a memory unit and a processor unit coupled to the memory unit, where the processor unit is configured with processor executable instructions to detect a first gesture performed relative to a first data item displayed on the electronic device, where the first data item constituting a set of second data items. Further, the processor unit is configured to cause to display the set of second data items along with the first data item on the electronic device. Further, the processor unit is configured to detect a second gesture performed on the first data item. Further, the processor unit is configured to cause to display a set of third data items constituting the second data item from the set of second data items.

Accordingly the embodiments herein provide a computer program product including a computer executable program code recorded on a computer readable non-transitory storage medium. The computer executable program code when executed causing the actions including detecting a first gesture performed relative to a first data item displayed on the electronic device, where the first data item constitutes a set of second data items. Further, the computer executable program code when executed causing the actions including causing to display the set of second data items along with the first data item on the electronic device. Further, the computer executable program code when executed causing the actions including detecting a second gesture covering a distance from the first data item. Further, the computer executable program code when executed causing the actions including causing to display selection of at least one second data item from the set of second data items based on the distance.

Accordingly the embodiments herein provide a computer program product including a computer executable program code recorded on a computer readable non-transitory storage medium. The computer executable program code when executed causing the actions including detecting a first gesture performed relative to a first data item displayed on the electronic device, where the first data item constituting a set of second data items. Further, the computer executable program code when executed causing the actions including causing to display the set of second data items along with the first data item on the electronic device. Further, the computer executable program code when executed causing the actions including detecting a second gesture performed on the first data item. Further, the computer executable program code when executed causing the actions including causing to display a set of third data items constituting at least one of the second data item from the set of second data items.

Accordingly the embodiments herein provide a method for selecting a data item from a directory in an electronic device. The method comprises detecting a first touch input dragging a first object for a predetermined region of a screen of the electronic device, displaying at least one second object for at least one item which is included in the folder on the electronic device based on the first touch input, detecting a second touch input to select one object among the at least one second object, and performing an item corresponding to the selected object.

Accordingly the embodiments herein provide an electronic device for selecting a data item from a directory. The electronic device comprises a controller configured to detect a first touch input dragging a first object for a folder to a predetermined region of a screen of the electronic device, display at least one second object for at least one item which is included in the folder on the electronic device based on the first touch input, detect a second touch input to select one object among the at least one second object, and perform an item corresponding to the selected object.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

This invention is illustrated in the accompanying drawings, throughout which like reference letters indicate corresponding parts in the various figures. The embodiments herein will be better understood from the following description with reference to the drawings.

FIG. 1 illustrates a block diagram of an electronic device for selecting a data item from a directory, according to an embodiment of the present invention.

FIGS. 2A and 2B illustrate various units of a processor unit, according to an embodiment as disclosed herein.

FIG. 3 illustrates a flow diagram illustrating a method for selecting a data item from a directory, according to an embodiment of the present invention.

FIG. 4 illustrates a flow diagram illustrating a context based method for selecting a data item from a directory, according to an embodiment of the present invention.

FIGS. 5A to 5F illustrate an example illustration in which a “Glide Motion” is performed on a directory displayed on a screen of an electronic device to select and execute a “Word File-3”, according to an embodiment of the present invention.

FIGS. 6A to 6D illustrate an example illustration in which a horizontal “Glide Motion” is performed on a directory displayed on a screen of an electronic device to select and execute an “Excel File-1”, according to an embodiment of the present invention.

FIGS. 7A to 7H illustrate an example illustration in which a “Glide Motion” is performed on a directory displayed on a screen of an electronic device to select multiple data items, according to an embodiment of the present invention.

FIGS. 8A to 8G illustrate an example illustration in which a “Glide Motion” is performed on a directory displayed on a screen to display selected multiple data items on a screen edge of an electronic device, according to an embodiment of the present invention.

FIGS. 9A to 9D illustrate an example illustration in which a “Glide Motion” is performed on a “Music Icon” for context based navigation to select context related content, according to an embodiment of the present invention.

FIGS. 10A to 10F illustrate an example illustration in which a “Glide Motion” is performed on a directory displayed on a screen of an electronic device to select and execute a “File-12”, according to an embodiment of the present invention.

FIGS. 11A to 11G illustrate an example illustration in which a user is provided with an option to toggle navigation side to select and execute a “File-12”, according to an embodiment of the present invention.

FIGS. 12A to 12F illustrate an example illustration in which a “Glide Motion” is performed on a “Gallery Icon” displayed on a screen of an electronic device for providing a user with options to input multiple contexts during an ongoing context based navigation, according to an embodiment of the present invention.

FIGS. 13A to 13E illustrate an example illustration in which a “Glide motion” is performed on a directory displayed on a first screen of an electronic device, according to an embodiment of the present invention.

FIG. 14 illustrates a computing environment implementing the method for selecting a data item from a directory in the electronic device, according to an embodiment of the present invention.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The embodiments herein disclose a method for selecting a data item from a directory in an electronic device. The method includes detecting a first gesture performed relative to a first data item displayed on the electronic device, where the first data item constitutes a set of second data items. Further, the method includes causing to display the set of second data items along with the first data item on the electronic device. Further, the method includes detecting a second gesture covering a distance from the first data item. Further, the method includes causing to display selection of at least one second data item from the set of second data items based on the distance.

In an embodiment, the method further includes detecting a third gesture performed on the selected second data item. Further, the method includes holding the second data item by replicating the second data item at a data item clipboard. Further, the method includes continuing selection of data items from the directory, where the data item clipboard holds a plurality of data items selected from the directory while the second gesture is performed.

In an embodiment, the display of selection of the second data item(s) is transitioned based on the distance covered while the second gesture is being performed.

In an embodiment, the first data item is transitioned to display the second data item from the set of second data items based on the distance covered by the second gesture.

In an embodiment, the first gesture is performed on the first data item relative to at least one glide displayed on the electronic device, where each of the glide is displayed at a predefine portion of the electronic device.

In an embodiment, the set of second data items is dynamically defined based on a context of the first data item.

In an embodiment, the first data item is displayed on a first portion of a first screen of the electronic device; and where the set of second data items are displayed on a second portion of a second screen of the electronic device.

In an embodiment, the first data item is displayed on a first portion of a screen of the electronic device, where the set of second data items are displayed on a second portion of the screen of the electronic device.

Further, the embodiments herein disclose a method for selecting the data item from the directory in the electronic device. The method includes detecting the first gesture performed relative to the first data item displayed on the electronic device, where the first data item constituting the set of second data items. Further, the method includes causing to display the set of second data items along with the first data item on the electronic device. Further, the method includes detecting the second gesture performed on the first data item. Further, the method includes causing to display a set of third data items constituting the second data item from the set of second data items.

In an embodiment, the method further comprises detecting the third gesture performed on a third data item from the set of third data items. Further, the method includes causing to display the second data item from the set of second data items on the electronic device.

In an embodiment, the first gesture is performed on the first data item relative to at least one glide displayed on the screen of the electronic device, where each of the glide is displayed at the predefine portion of the screen of the electronic device.

In an embodiment, the set of second data items is dynamically defined based on the context of the first data item.

In an embodiment, each of the third data item is displayed by hinging with the first data item.

In an embodiment, the user is provided with a displacement function by which the user can navigate and access the desired data item in the directory.

In the conventional systems and methods, for example, the user selects the directory which the user intends to browse. After selecting the directory, the data items of the selected directory are displayed to use with the toolbar indicating the current selected directory. Further, the user selects “Office documents” directory as the user does not finds the required file in the current directory. The immediate contents of the “Office documents” directory are displayed to the user with the toolbar indicating the current directory and direction of traversal. The user is able to locate the required document file and performs the select input event to execute the document.

Unlike the conventional systems and methods, the proposed method aims to improve the overall user convenience by providing options to select the data item from the directory in simple and smooth ways. Further, the proposed method can be used for easily locating and selecting a particular file in a directory, more particularly in a multi-hierarchal directory system. The proposed method is a new way of navigation by performing a glide motion to locate, select, or execute the desired data item. The user can perform multi-touch events while performing the navigation to simultaneously select data items (such as files or folders) at different levels in the directory. Further, the proposed method can be used to automatically categorize the various data items available at different locations of the directory based on the context associated with an application icon on which the user performs a glide motion. For example, if the user performs a glide motion on a Music icon then all the music related folders and files available at different location of the directory is automatically fetched and seamlessly displayed to the user so that the user can easily view and navigate throughout the contextually related files at various locations to locate the files of interest.

Further, a robust and simple mechanism for selectively accessing files of interest in multi-hierarchal directory. The user is not required to remember name or part of the name of the file of interest to locate and select the file of interest in the directory. Further, the user is not required to undergo multiple select events or steps corresponding at each level of hierarchy in order to locate the file of interest.

The labels “First”, “Second”, and “Third”, are used merely for illustrative purpose only.

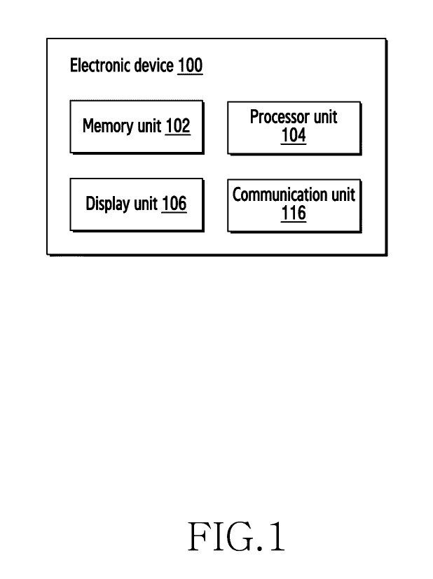

Referring now to the drawings, and more particularly to FIGS. 1 through 14, where similar reference characters denote corresponding features consistently throughout the figures, there are shown preferred embodiments.

FIG. 1 illustrates a block diagram of an electronic device for selecting a data item from a directory, according to an embodiment of the present invention. The electronic device 100 can be, for example, a laptop, a desktop computer, a mobile phone, a smart phone, Personal Digital Assistants (PDAs), a tablet, a phablet, a consumer electronic device, dual display devices, or any other electronic device. In an embodiment, the electronic device 100 includes a memory unit 102, a processor unit 104, a display unit 106, and a communication unit 108.

The memory unit 102 may include one or more computer-readable storage media. The memory unit 102 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory unit 102 may, in some examples, be considered a non-transitory storage medium. The term “non-transitory” may indicate that the storage medium is not embodied in a carrier wave or a propagated signal. However, the term “non-transitory” should not be interpreted to mean that the memory unit 102 is non-movable. In some examples, the memory unit 102 can be configured to store larger amounts of information than the memory. In certain examples, a non-transitory storage medium may store data that can, over time, change (e.g., in Random Access Memory (RAM) or cache).

In an embodiment, the processor unit 104 can be configured to detect a first gesture performed relative to a first data item displayed on the electronic device 100. The first gesture can be, for example, a long press event, a hover gesture, a swipe gesture, a touch gesture, or any type of gesture. The first data item can be any executable or non-executable data item which is organized in a directory structure. In an example, the first data item can be a folder icon, an application icon (such as a Music application icon, a Social Networking Site (SNS) application icon, and Gallery icon), or the like. In an example, the folder icon permits the user to view the contents of the folder. The contents of the folder may comprise additional folders, files, or combination of same. The first gesture is performed on the first data item relative to at least one glide displayed on the electronic device 100, wherein each of the glide is displayed at a predefine portion of the electronic device 100. The first data item constitutes a set of second data items. The second data item, for example, can be any executable or non-executable data item which is organized in the directory structure. In an example, the second data item can be the folder, the file, or combination of same.

Further, the processor unit 104 can be configured to cause to display the set of second data items along with the first data item on the electronic device 100. In an embodiment, the set of second data items is dynamically defined based on context of the first data item. Further, the processor unit 104 can be configured to detect a second gesture covering a distance from the first data item. In an embodiment, the second gesture can be a “Glide Motion”. The “Glide Motion” can be, for example, a vertical glide motion, a horizontal glide motion, or any other type of glide motion. Further, the processor unit 104 can be configured to cause to display selection of at least one second data item from the set of second data items based on the distance. The display of selection of the at least one second data item is transitioned based on the distance covered while the second gesture is being performed. In an embodiment, the first data item is transitioned to display the second data item from the set of second data items based on the distance covered by the second gesture.

Further, the processor unit 104 can be configured to detect a third gesture performed on the selected second data item; and holding the second data item by replicating the second data item at a data item clipboard. In here, the data item clipboard may be a predetermined storage space of the electronic device. Further, the method includes continuing selection of the data items from the directory, where the data item clipboard holds a plurality of data items selected from the directory while the second gesture is performed. In an embodiment, the third gesture can be the hover gesture, the swipe gesture, the slide gesture, the touch gesture, or any other gesture.

In an embodiment, the display unit 112 displays the first data item on a first portion of a screen of the electronic device 100, where the set of second data items are displayed on a second portion of the screen of the electronic device 100. In another embodiment, display unit 112 displays the first data item on a first portion of a first screen of the electronic device 100; where the set of second data items are displayed on a second portion of a second screen of the electronic device 100.

In another embodiment, the processor unit 104 can be configured to detect the first gesture performed relative to the first data item displayed on the electronic device 100, where the first data item constitutes the set of second data items. Further, the processor unit 104 can be configured to cause to display the set of second data items along with the first data item on the electronic device 100; and detect the second gesture performed on the first data item. Further, the processor unit 104 can be configured to cause to display a set of third data items constituting the second data item from the set of second data items.

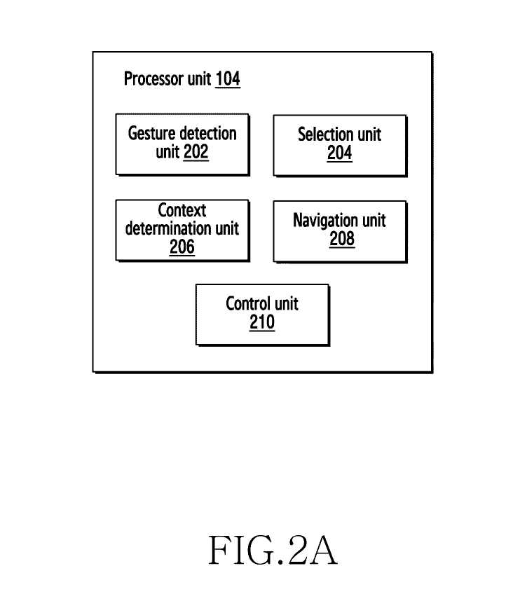

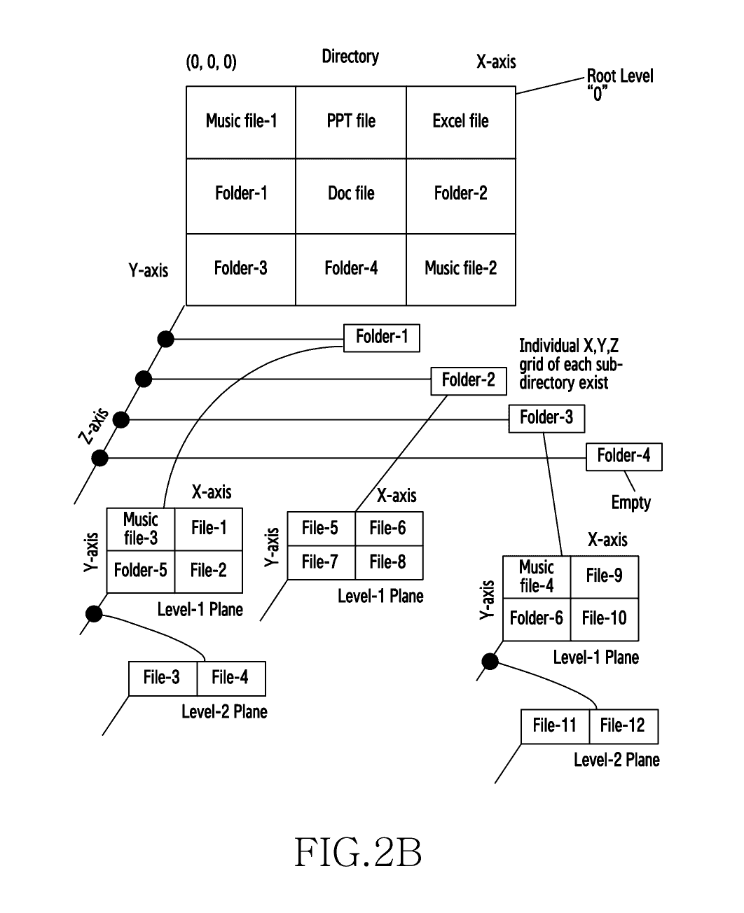

Further, the processor unit 104 can be configured to detect the third gesture performed on a third data item from the set of third data items; and cause to display the second data item from the set of second data items on the screen of the electronic device 100. In an embodiment, the third data item is displayed by hinging with the first data item. Further, the additional functionalities of the processor unit 104 are explained in conjunction with the FIG. 2.

Unlike the conventional systems and methods, the proposed mechanism enhances the overall user experience thus, simplifying the navigation across multiple hierarchies of organized data stored in the electronic device 100. Further, the proposed mechanism simplifies the overall process to access, identify, and execute the data item in the directory. Also, appropriate user interface for providing the functionality across the desired output screen of the electronic device 100.

The FIG. 1 illustrates a limited overview of the electronic device 100 but, it is to be understood that another embodiment is not limited thereto. Further, the electronic device 100 can include different units communicating among each other along with other hardware or software components. By way of illustration, both an application running on an electronic device 100 and the electronic device 100 can be the component.

FIGS. 2A and 2B illustrate various units of the processor unit 104, according to an embodiment of the present invention. In an embodiment, the processor unit 104 includes a gesture detection unit 202, a selection unit 204, a context determination unit 206, a navigation unit 208, and a control unit 210 as shown in the FIG. 2A.

The gesture detection unit 202 is in direct communication with the display unit 106. All the events such as touch, gesture, or motion based events are detected by the gesture detection unit 202. The gesture detection unit 202 can be configured to detect the first gesture performed relative to the first data item displayed on the electronic device 100, where the first data item constitutes the set of second data items. In an embodiment, for the touch based events, the gesture detection unit 202 can be configured to parse coordinates data, current active screen, and type of selection event performed by the user.

In an embodiment, the gesture detection unit 202 can be configured to identify the long press event or the “Glide Motion” (i.e., first gesture) performed by the user over the selected data item. For determining the “Glide Motion” performed by the user, the gesture detection unit 202 uses a “HOLD Timer” to identify and distinguish between the “Glide Motion” and the long press event. Further, the gesture detection unit 202 can be configured to pass the information to the selection unit 204.

The selection unit 204 can be configured to track the multi-touch events performed by the user in the ongoing navigation session. Further, the selection unit 204 can be configured to store the selected data items during the ongoing navigation session in a multiple selection information table. The information is then transmitted to the context determination unit 206. In an embodiment, the selection unit 204 can be configured to implement a “Merge Function” to provide the user an option to merge multiple data items in the ongoing navigation session and navigate through the data of the selected data items. The selection unit 204 identifies the Multi touch or single touch based merge operation on the data items stored in the multiple selection information table, the merge function outputs a linked set of data of the merged data items to the context determination unit 206.

The context determination unit 206 can be configured to identify the active context for which the user intends to retrieve the relevant and required data items. In an embodiment, the context determination is performed based on a set of predefined but configurable rules. The rules are stored in rule set in the memory unit 102 of the electronic device 100. Further, the rule set is priority based; and also the user can set or override their personal priorities with respect to the context determination. In an embodiment, the rule set is dynamic and configurable. The user is provided with the options to manually specify the preferences which will help in determining the current active context. The pre-configured set of rule are described below:

Based on the category or type of the data item selected.

Based on the current runtime information. If the currently active application or services corresponds to a particular kind of activity being performed by the user then, the context can be determined.

Based on the type of the parent activity of the selected data item.

In an embodiment, the input received by the context determination unit 206 can be the single selected data item or the merged information of the multiple selected data item. The user may intend to navigate through the data which the user considers to be related i.e., the user may be willing to retrieve a “Music File” and at the same time “Image Files” or “Video Files”. The user can perform the merge operation during the navigation session. Further, the context determination unit 206 can be configured to transfer the information including the relevant context and the selected data item to the navigation unit 208. In an example, the context determination function can be used to classify and display the relevant content to the user. The user while searching for a particular kind, type of data, the data items specific to certain applications, or the data items specific to active context, need not have to worry about the related organization of the directory. By using the context determination function, relevant and related data items are displayed to the user.

The navigation unit 208 can be configured to identify the requested data items. Further, the navigation unit 208 can be configured to create a data structure in the form of a three-dimensional (3D) navigation map as shown in FIG. 2B. The navigation map is a 3D map mapping the coordinates of the screen to the available data items. The navigation unit 208 can be configured to create the navigation map from fetching the data with respect to the selected data item from the memory unit 102 and applying the received context to the fetched data as shown in the FIG. 2B. In an embodiment, the user is provided with a displacement function by which the user can navigate and access the desired data. The displacement function maps the entire hierarchy of the targeted directory into the navigation map. Further, the detailed description for determining, by the navigation unit 208, content related to the determined context are described as follows.

The navigation unit 208 can be configured to identify and create a suitable hierarchy from the electronic device 100 for the content related to the context. The set of rules to be followed to determine the content and hierarchy are as described below:

The directories available on the home screen of the electronic device 100 are considered as available on “Root Level 0”.

If the multiple directories are available on the home screen which match the provided content, then the “Root Level 0” directory is identified based on criteria set A, and assign the rest of directories as sub-directories to the identified root directory.

If the multiple directories are located on multiple screens, then individual preference per screen is determined by the screen numbers and on a particular screen where the levels are determined by the criteria set A.

The detailed explanation of the criteria set A is described as below:

Count the number of data items which are immediate child of the directory and which match the context.

Based on the count of the data items, the context and present immediate level is matched and the directory including the maximum number of data items are identified.

All other directories matching the context should be placed inside the identified root directory as the sub-directory.

Further, the navigation map function identifies the multi-level hierarchies for the required selected data item and creates the 3D map as shown in the FIG. 2B. The below described rules are used in mapping:

In case of the directory, the data items (i.e., Music File-1, PPT File, Excel File, Folder-1, Doc File, Folder-2, Folder-3, Folder-4, and Music File-2) available inside the directory are arranged on the map generated over X, Y-plane. The data items are precisely allocated coordinates on the X, Y-map.

In case where the directory includes the sub-directory, the location of the sub-directory (i.e., Folder-1, Folder-2, Folder-3, and Folder-4) is fixed on the X, Y-plane and the contents of the sub-directory are addressed on a new X, Y plane for the sub-directory mapped on Z-plane of the 3D navigation map as shown in the FIG. 2B.

The control unit 210 is in communication with the display unit 104 to display the user interface to the user. The control unit 210 receives the navigation map and appropriately scales as per the available screen and area information; and provides as output to the display unit 104. Further, the control unit 210 utilizes the following functions such as a location function and a scale function.

Location Function:

The location function determines the appropriate location of the selected data item for navigation to be displayed to the user on the screen of the electronic device 100. In an embodiment, if the electronic device 100 has multiple screens (i.e., dual touch screen including a front and back touch screen), then the selected data item is moved to the back screen and the content of the data item is displayed on the front screen to the user while navigating. In another embodiment, if the electronic device 100 is a single touch screen, then the selected data item is moved to any of the corners of the screen as per the preference of the user (i.e., the data item can be moved to top-left, top-right, bottom-left, or bottom-right).

Scale Function:

The scale function is responsible for the “Glide Function”. The scale function helps with proportional scaling of the available screen depth and width based on the depth of the navigation map. Further, the working of the scale function is described below:

Initially, the current active screen is determined.

Calculating the properties of the active screen, depth, and width.

The total depth of the active screen is proportionally divided as per MAX-LEVEL (i.e., represents maximum depth level of the navigation map).

Within the proportion of the each level, the scale is divided as per the number of sub-directories at each level.

When the user initiates a vertical Glide motion, the contents are displayed to the user. The units of distance travelled.

If the user intends to reside at a location, the HOLD-TIMER (i.e., used to identify if the user intends to go inside the currently visible content while performing the vertical glide motion) becomes active. Further, with the expiry of the hold timer, the properties of the sub-directory to the unit of distance become the CUR-WIDTH (i.e. represents the width of the current Active directory) and CUR-DEPTH (i.e., represents the depth of the current active directory).

If the user needs to return to the parent directory or glide back to previous content view, then the user needs to perform the vertical glide motion in upward direction.

In an example, the control unit 210 can be configured to determine the appropriate and suitable modes of user interface display based on the capabilities of the electronic device 100. In an example, the “Glide motion” is employed to select the data item where the glide is internally mapped to display of the content.

In an embodiment, if the MAX-LEVELS are more, then there will be a determination of dynamic threshold and the available screen is accordingly scaled in appropriate parts of the navigation map. Unlike the conventional systems and methods, in the proposed mechanism, the user can perform multiple selections across multiple hierarchies to select and execute the user intended data item. The user can perform the “Glide motion” on the selected directory of the application icon to access or execute the data item. The “Glide motion” pertains to providing the user with the option to move the selected directory along predefined directions to supplement the navigation across the directories.

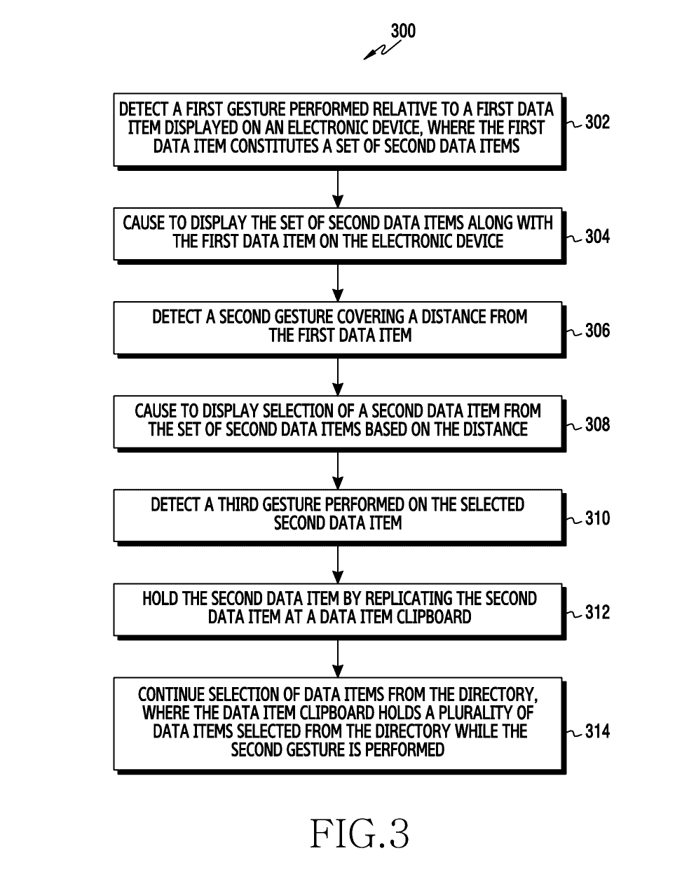

FIG. 3 illustrates a flow diagram illustrating a method 300 for selecting the data item from the directory, according to an embodiment of the present invention.

At step 302, the method 300 includes detecting the first gesture performed relative to the first data item displayed on the electronic device, where the first data item constitutes the set of second data items. The method 300 allows the processor unit 104 to detect the first gesture performed relative to the first data item displayed on the electronic device, where the first data item constitutes the set of second data items. The first gesture can be, for example, the long press event, the hover gesture, the swipe gesture, the touch gesture, or any type of gesture. The first data item can be any executable or non-executable data item which is organized in the directory structure.

In an example, the first data item can be the folder icon, the application icon (such as the Music application icon, the SNS application icon, and Gallery icon), or the like. In an example, the folder icon permits the user to view the contents of the folder. The contents of the folder may comprise additional folders, files, or combination of same. In an embodiment, the first gesture is performed on the first data item relative to at least one of the glide zone displayed on the electronic device 100. Each glide zone is displayed at the predefine portion of the electronic device 100. In an embodiment, the set of second data items is dynamically defined based on context of the first data item.

At step 304, the method 300 includes causing to display the set of second data items along with the first data item on the electronic device 100. The method 300 allows the processor unit 104 to cause to display the set of second data items along with the first data item on the electronic device 100. The second data item, for example, can be any executable or non-executable data item which is organized in the directory structure. In an example, the second data item can be the folder, the file, or combination of same.

At step 306, the method 300 includes detecting the second gesture covering a distance from the first data item. The method 300 allows the processor unit 104 to detect the second gesture covering the distance from the first data item. In an embodiment, the second gesture can be the “Glide Motion”. The “Glide Motion” can be, for example, the vertical glide motion, the horizontal glide motion, or any other type of glide motion

At step 308, the method 300 includes causing to display selection of the second data item from the set of second data items based on the distance. The method 300 allows the processor unit 104 to cause to display selection of the second data item from the set of second data items based on the distance. In an embodiment, the display of selection of the second data item is transitioned based on the distance covered while the second gesture is being performed. In an embodiment, the first data item is transitioned to display the second data item from the set of second data items based on the distance covered by the second gesture.

At step 310, the method 300 includes detecting the third gesture performed on the selected second data item. The method 300 allows the processor unit 104 to detect the third gesture performed on the selected second data item. In an embodiment, the third gesture can be the hover gesture, the swipe gesture, the slide gesture, the touch gesture, or any other gesture.

At step 312, the method 300 includes holding the second data item by replicating the second data item at the data item clipboard. The method 300 allows the processor unit 104 to hold the second data item by replicating the second data item at the data item clipboard.

At step 314, the method 300 includes continuing selection of data items from the directory, where the data item clipboard holds the plurality of data items selected from the directory while the second gesture is performed. The method 300 allows the processor unit 104 to continue selection of data items from the directory, where the data item clipboard holds the plurality of data items selected from the directory while the second gesture is performed.

In an embodiment, the first data item is displayed on the first portion of the first screen of the electronic device 100, where the set of second data items are displayed on the second portion of the second screen of the electronic device 100. In another embodiment, the first data item is displayed on the first portion of the screen of the electronic device 100, where the set of second data items are displayed on the second portion of the screen of the electronic device 100. Unlike the conventional systems and methods, the proposed mechanism provides the user an ease of access to the intended data item which can be available in the multiple level arrange hierarchy within the electronic device 100. Further, the proposed mechanism provides access to such data items based on dynamically derived context.

The various actions, acts, blocks, steps, or the like in the method 300 may be performed in the order presented, in a different order or simultaneously. Further, in some embodiments, some of the actions, acts, blocks, steps, or the like may be omitted, added, modified, skipped, or the like without departing from the scope of the invention.

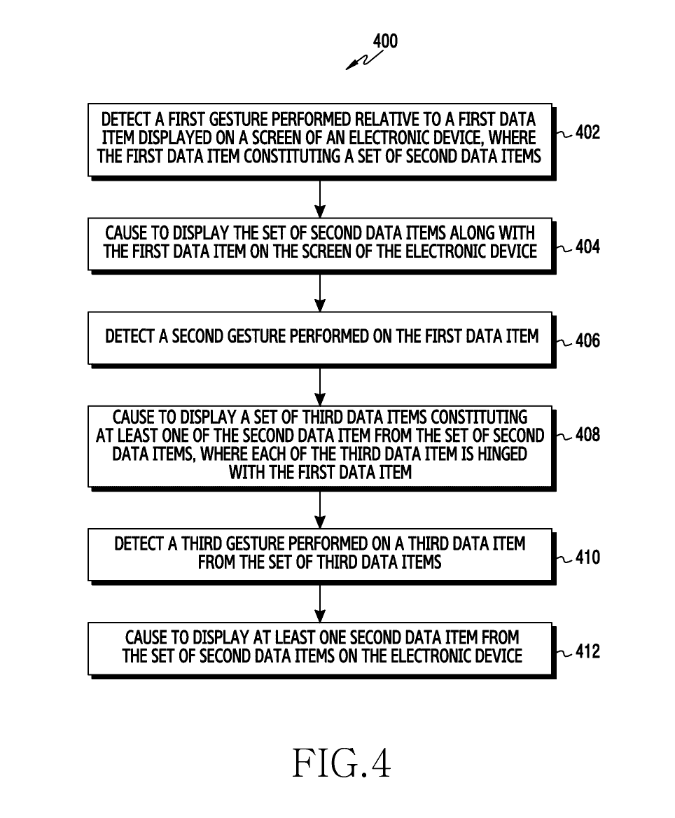

FIG. 4 illustrates a flow diagram illustrating a context-based method 400 for selecting the data item from the directory in the electronic device 100, according to an embodiment of the present invention.

At step 402, the method 400 includes detecting the first gesture performed relative to the first data item displayed on the electronic device 100, where the first data item constituting the set of second data items. The method 400 allows the processor unit 104 to detect the first gesture performed relative to the first data item displayed on the electronic device 100, where the first data item constitutes the set of second data items.

The first gesture can be, for example, the long press event, the hover gesture, the swipe gesture, the touch gesture, or any type of gesture. The first data item can be any executable or non-executable data item which is organized in the directory structure. In an example, the first data item can be the folder icon, the application icon (such as the Music application icon, the SNS application icon, and Gallery icon), or the like. In an example, the folder icon permits the user to view the contents of the folder. The contents of the folder may comprise additional folders, files, or combination of same. In an embodiment, the first gesture is performed on the first data item relative to the glide displayed on the electronic device 100, where each said glide is displayed at the predefine portion of the electronic device 100.

At step 404, the method 400 includes causing to display the set of second data items along with the first data item on the electronic device 100. The method 400 allows the processor unit 104 to cause to display the set of second data items along with the first data item on the electronic device 100. The second data item, for example, can be any executable or non-executable data item which is organized in the directory structure. In an example, the second data item can be the folder, the file, or combination of same. In an embodiment, the set of second data items is dynamically defined based on context of the first data item.

At step 406, the method 400 includes detecting the second gesture performed on the first data item. The method 400 allows the processor unit 104 to detect the second gesture performed on the first data item. At step 408, the method 400 includes causing to display the set of third data items constituting the second data item from the set of second data items. The method 400 allows the processor unit 104 to cause to display the set of third data items constituting the second data item from the set of second data items.

At step 410, the method 400 includes detecting the third gesture performed on the third data item from the set of third data items. The method 400 allows the processor unit 104 to detect the third gesture performed on the third data item from the set of third data items. In an embodiment, the third gesture can be the hover gesture, the swipe gesture, the slide gesture, the touch gesture, or any other gesture. At step 412, the method 400 includes causing to display the second data item from the set of second data items on the electronic device 100. The method 400 allows the processor unit 104 to cause to display the second data item from the set of second data items on the electronic device 100.

In an embodiment, the first data item is displayed on the first portion of the first screen of the electronic device 100, where the set of second data items are displayed on the second portion of the second screen of the electronic device 100. In another embodiment, the first data item is displayed on the first portion of the screen of the electronic device 100, where the set of second data items are displayed on the second portion of the screen of the electronic device 100. In an embodiment, the third data item is displayed by hinging with the first data item.

Unlike the conventional systems and methods, the proposed mechanism provides the user an easy approach to access any know or unknown data item with the multiple hierarchies. Further, the proposed mechanism for providing the context related data. Multiple touch inputs are performed by the user which helps the user to bookmark the required data item for subsequent selection of the data item in the navigation session.

The various actions, acts, blocks, steps, or the like in the method 400 may be performed in the order presented, in a different order or simultaneously. Further, in some embodiments, some of the actions, acts, blocks, steps, or the like may be omitted, added, modified, skipped, or the like without departing from the scope of the invention.

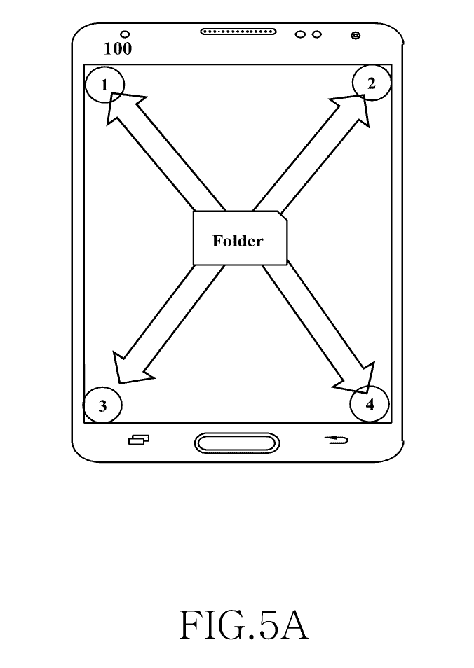

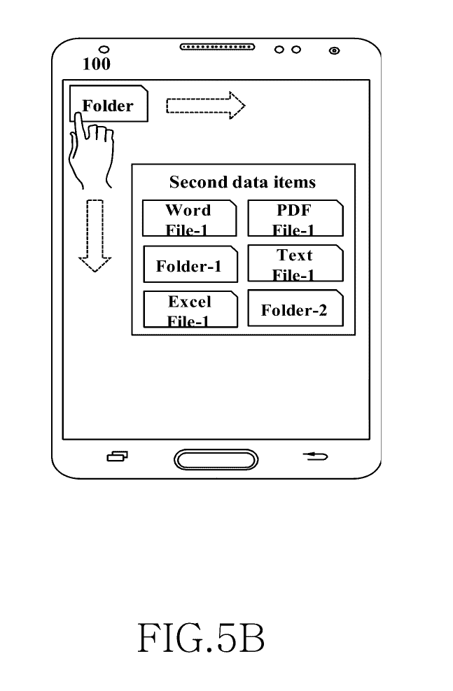

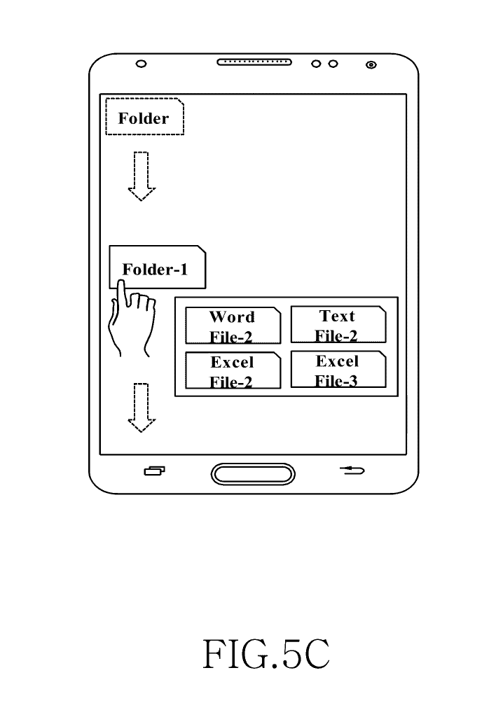

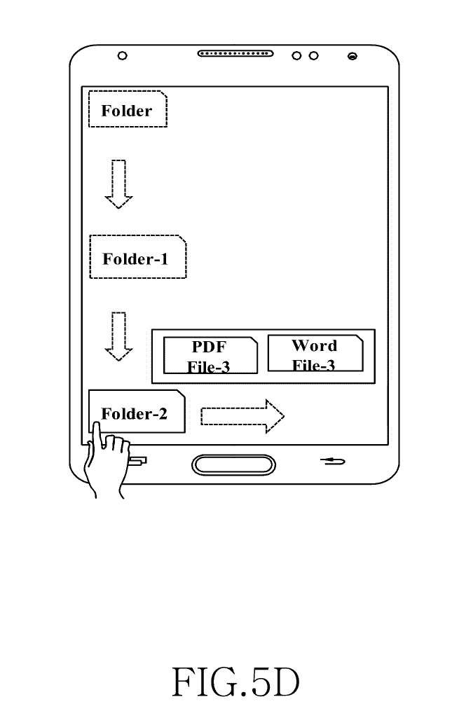

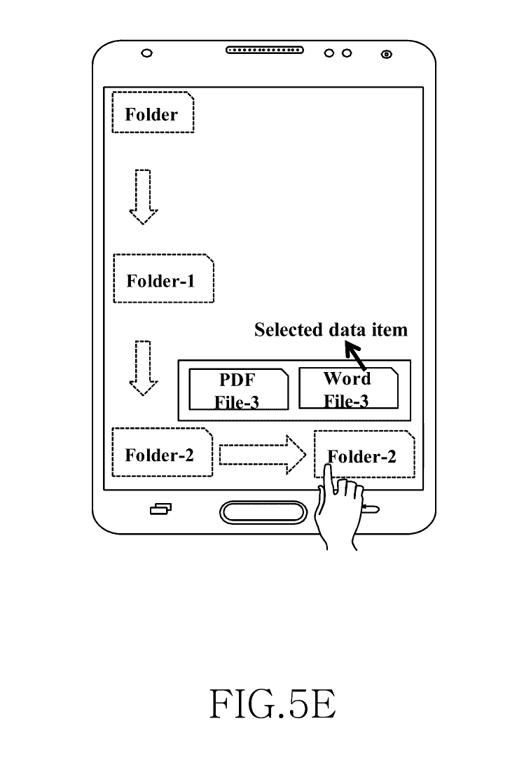

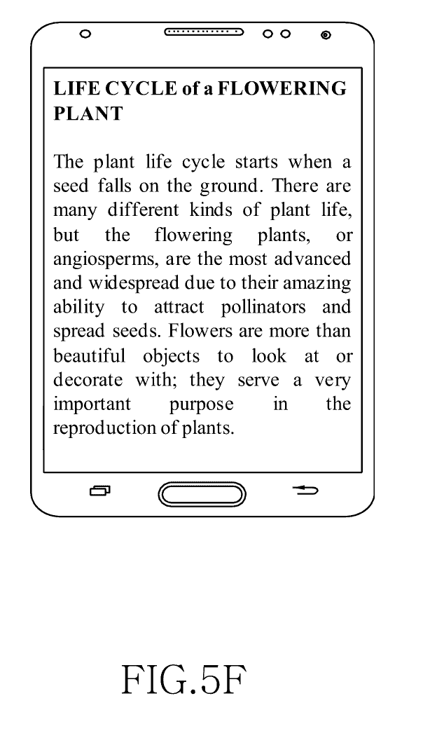

FIGS. 5A to 5F illustrate an example illustration in which the “Glide Motion” is performed on the directory displayed on the screen of the electronic device 100 to select and execute a “Word File-3”, according to an embodiment of the present invention. Initially, the user selects the “Folder” (i.e., directory) which the user intends to browse for selecting the “Word File-3” (i.e., data item) in the Folder. After selecting the “Folder” displayed on the home screen of the electronic device 100, the processor unit 104 can be configured to activate the “Glide Screen” and displays “4” Glide zones on the screen of the electronic device 100. The “4” Glide zones are displayed to the user for initiating the navigation to select the document as shown in the FIG. 5A.

As shown in the FIG. 5B, the user selects the “TOP-LEFT” glide zone (i.e., glide zone-1) where the user performs the long press event (i.e., first gesture) on the selected “Folder icon” for a predefined amount of time (i.e., “HOLD TIMER” period). The “Folder” constitutes the sub-folders, files, or the like (i.e., set of second data items). After detecting the long press event, the processor unit 104 can be configured to cause to display the content (i.e., “Word File-1”, “PDF File-1”, “Folder-1”, “Text File-1”, “Excel File-1”, and “Folder-2”) of the “Folder”. As the “Word File-3” which is user intended file is not available in displayed content, the user further needs to navigate vertically down to browse the content in the sub-folders (i.e., “Folder-1”).

As shown the FIG. 5C, the user performs the vertical glide motion (i.e., second gesture) downwards covering the distance from the “Folder”. After detecting the vertical glide motion, the processor unit 104 can be configured to cause to display the content (i.e., “Word File-2”, “Text File-2”, “Excel File-2”, and “Excel File-3”). As the “Word File-3” which is user intended file is not available in displayed content, the user further needs to navigate vertically down to browse the content (i.e., “Folder-2”).

Further, as shown in the FIG. 5D, the user further performs the vertical glide motion downwards covering the distance from the “Folder-1”. After detecting the vertical glide motion, the processor unit 104 can be configured to display the content (i.e., “PDF File-3 and “Word File-3”) on the electronic device 100. As the user intended file is available in the sub-folder “Folder-2”, the user performs the long press event on the “Folder-2” for the “HOLD-TIMER” to expire. Further, the user needs to perform the horizontal glide motion for selection the “Word File-3”.

Further, as shown in the FIG. 5E, the user performs the horizontal glide motion covering the distance to highlight the “Word File-3”. As shown in the FIG. 5F, the user ends the navigation and selects the “Word File-3” to be executed. The processor unit 104 can be configured to display the executed “Word File-3” on the screen of the electronic device 100.

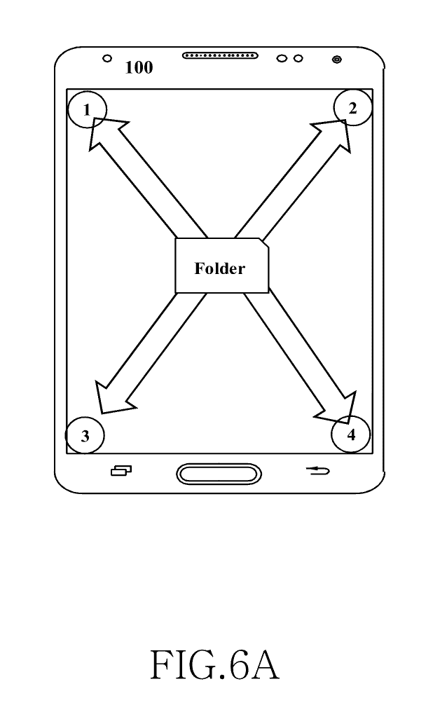

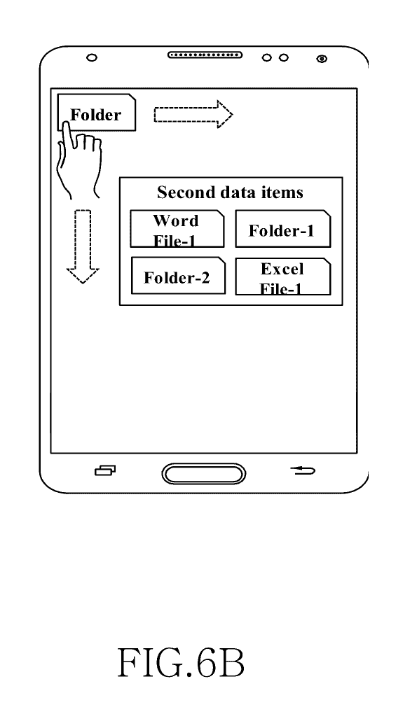

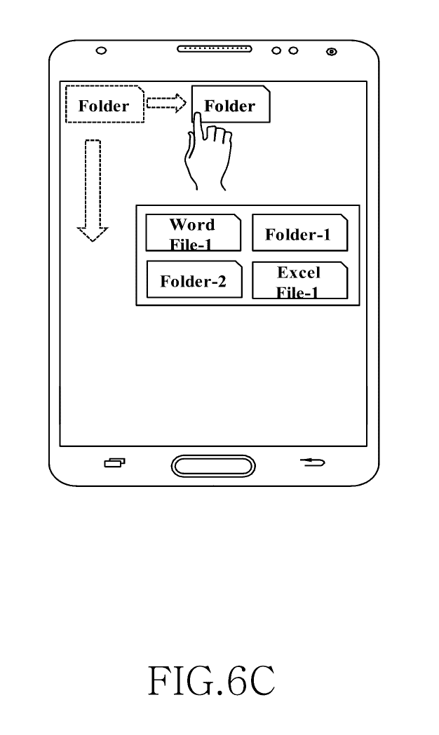

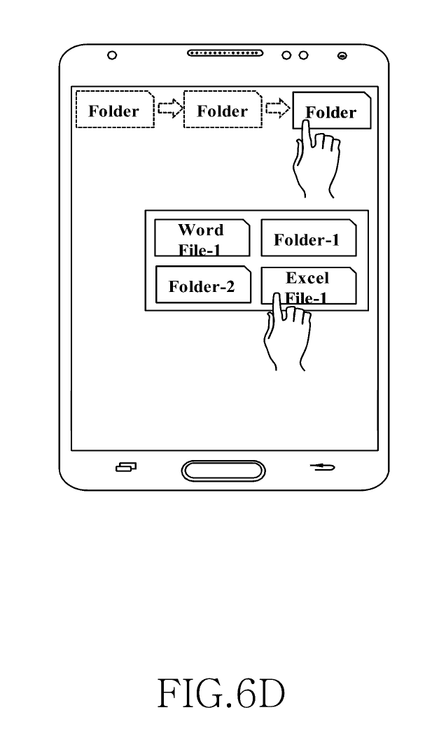

FIGS. 6A to 6D illustrate an example illustration in which the horizontal glide motion is performed on the directory displayed on the screen of the electronic device 100 to select and execute the “Excel File-1”, according to an embodiment of the present invention. Initially, the user selects the “Folder” (i.e., directory) which the user intends to browse for selecting the “Excel File-1” (i.e., data item) in the Folder. After selecting the “Folder” displayed on the home screen of the electronic device 100, the processor unit 104 can be configured to activate the “Glide Screen” and displays “4” Glide zones on the screen of the electronic device 100. The “4” Glide zones are displayed to the user for initiating the navigation to select the “Excel File-1” as shown in the FIG. 6A.

As shown in the FIG. 6B, the user selects the “TOP-LEFT” glide zone (i.e., glide zone-1) where the user performs the long press event (i.e., first gesture) on the selected “Folder icon” for the predefined amount of time (i.e., “HOLD TIMER” period). The “Folder” constitutes the sub-folders, files, or the like (i.e., set of second data items). After detecting the long press event, the processor unit 104 can be configured to cause to display the content (i.e., “Word File-1”, “Folder-1”, “Folder-2”, and “Excel File-1”) of the “Folder”. As the “Excel File-1” which is user intended file is available in the displayed content, the user needs to navigate horizontally to select the “Excel File-1”.

As shown the FIG. 6C, the user performs the horizontal glide motion (i.e., second gesture) covering the distance. The display of selection of the second data item is transitioned based on the distance covered while the horizontal glide motion is being performed by the user. The horizontal axis is scaled as per the available executable data items in the “Folder” (i.e., current directory). The user covers the distance of one unit and the corresponding “Word File-1” is highlighted. As the “Word File-1” is not the user intended file, the user further needs to navigate horizontally to select the “Excel File-1”.

As shown in the FIG. 6D, the user further performs the horizontal glide motion covering the distance of two units from the first glide zone; the “Excel File-1” is highlighted. The user ends the navigation and selects the “Excel File-1” to be executed. The processor unit 104 can be configured to display the executed “Excel File-1” on the screen of the electronic device 100.

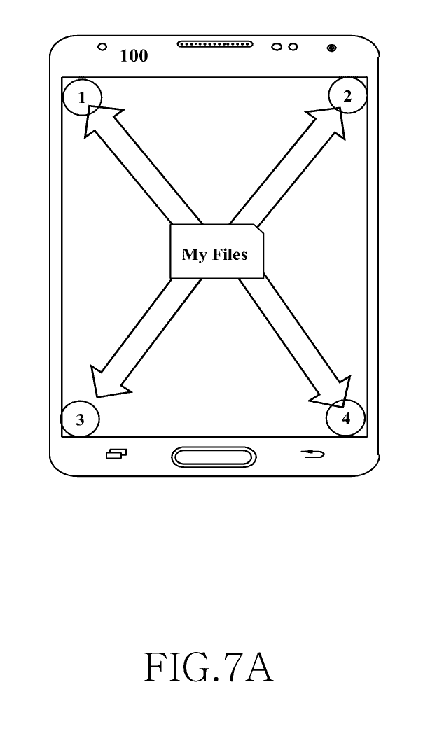

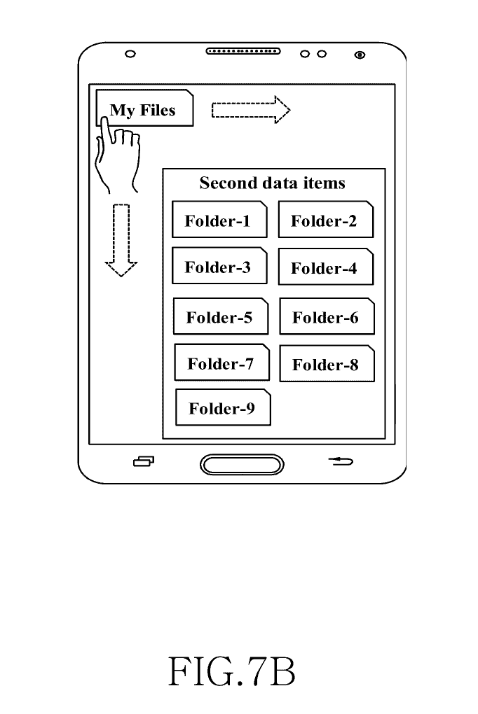

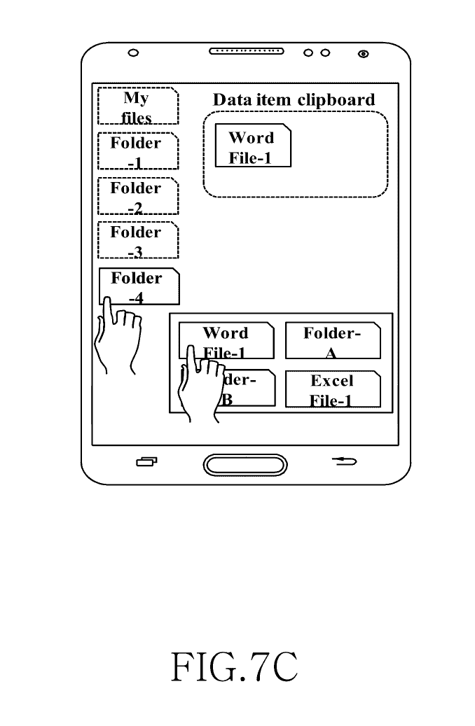

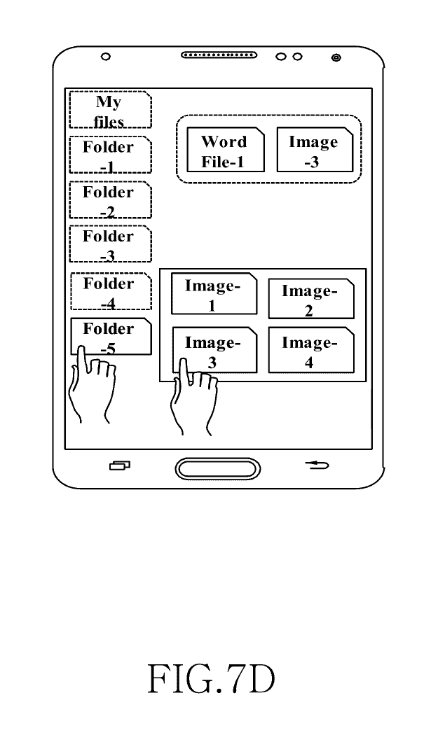

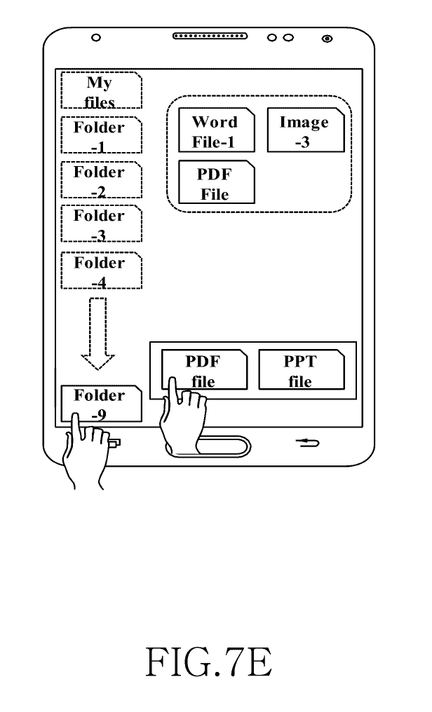

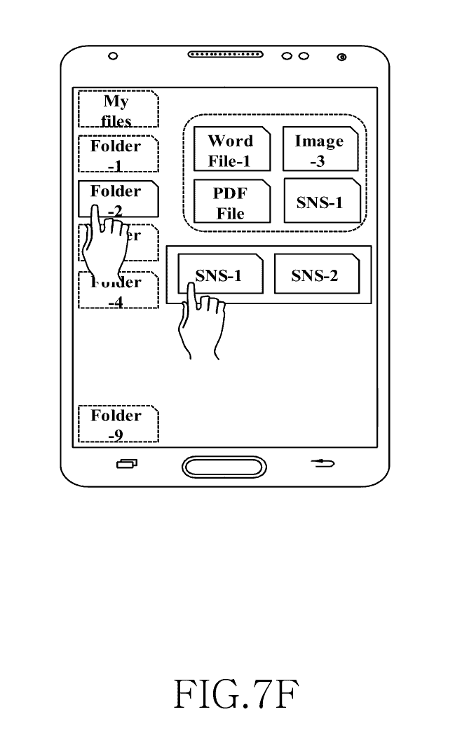

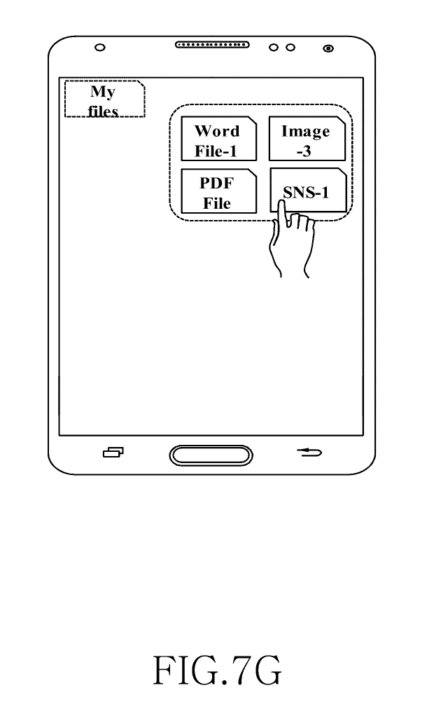

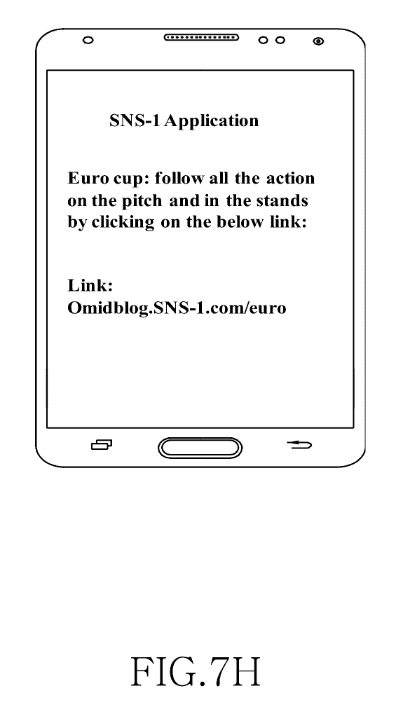

FIGS. 7A to 7H illustrate an example illustration in which the glide motion is performed on the directory displayed on the screen of the electronic device 100 to select multiple data items, according to an embodiment of the present invention. Initially, the user selects the “My Files” (i.e., directory) which the user intends to browse for selecting multiple data items. After selecting the “My Files” displayed on the home screen of the electronic device 100, the processor unit 104 can be configured to activate the “Glide Screen” and displays “4” Glide zones on the screen of the electronic device 100. The “4” Glide zones are displayed to the user for initiating the navigation to select the multiple data items as shown in the FIG. 7A.

As shown in the FIG. 7B, the user selects the “TOP-LEFT” glide zone (i.e., glide zone-1) where the user performs the long press event (i.e., first gesture) on the selected “My Files icon” for the predefined amount of time (i.e., “HOLD TIMER” period). The “My Files” constitutes the sub-folders, files, or the like (i.e., set of second data items). After detecting the long press event, the processor unit 104 can be configured to cause to display the content (i.e., “Folder-1”, “Folder-2”, “Folder-3”, “Folder-4”, “Folder-5”, “Folder-6”, “Folder-7”, “Folder-8”, and “Folder-9”) of the “My Files”. Further, the user needs to perform the vertically glide motion to navigate through the sub-folders.

As shown in the FIG. 7C, the user performs the vertical glide motion downwards covering the distance of 4 units from the glide zone-1 to glide to the “Folder-4”. After detecting the vertical glide motion, the processor unit 104 can be configured to cause to display the content (i.e., “Word File-1”, “Folder-A”, “Folder-B”, and “Excel File-1”) in the “Folder-4”. The user performs the third gesture to mark the “Word File-1” for future selection. After selecting the “Word File-1”, the processor unit 104 can be configured to hold the “Word File-1” at the data item clipboard. In an example, the “Word File-1” is transferred to a separate window at the top. Further, the user continues to perform the vertical glide motion in the downward direction.

As shown in the FIG. 7D, the user further performs the vertical glide motion downwards covering the distance of 5 units from the glide zone-1 to glide to the “Folder-5”. After detecting the vertical glide motion, the processor unit 104 can be configured to cause to display the content (i.e., “Image-1”, “Image-2”, “Image-3”, and “Image-4”) in the “Folder-5”. The user performs the third gesture to mark the “Image-3” for future selection. After selecting the “Image-3”, the processor unit 104 can be configured to hold the “Image-3” at the data item clipboard. In an example, the “Image-3” is transferred to the separate window at the top. Further, the user continues to perform the vertical glide motion in the downward direction.

As shown in the FIG. 7E, the user further performs the vertical glide motion downwards covering the distance of 9 units from the glide zone-1 to glide to the “Folder-9”. After detecting the vertical glide motion, the processor unit 104 can be configured to cause to display the content (i.e., “PDF File” and “PPT File”) in the “Folder-9”. The user performs the third gesture to mark the “PDF File” for future selection. After selecting the “PDF File”, the processor unit 104 can be configured to hold the “PDF File” at the data item clipboard. In an example, the “PDF File” is transferred to the separate window at the top.

As shown in the FIG. 7F, the user performs the vertical glide motion upwards to glide to the “Folder-2”. After detecting the vertical glide motion in the upward direction, the processor unit 104 can be configured to cause to display the content (i.e., “SNS-1” and “SNS-2”) in the “Folder-2”. The user performs the third gesture to mark the “SNS-1” for future selection. After selecting the “SNS-1”, the processor unit 104 can be configured to hold the “SNS-1” at the data item clipboard. In an example, the “SNS-1” is transferred to the separate window at the top of the screen of the electronic device 100. Further, the user ends the current vertical glide motion over the “My Files” directory and can able to select the “SNS-1” application to be executed from the items displayed in the data item clipboard.

As shown in the FIG. 7G, the user selects the “SNS-1” application icon. The navigation session is completed and the “SNS-1” application is launched and displayed on the screen of the electronic device 100 as shown in the FIG. 7H.

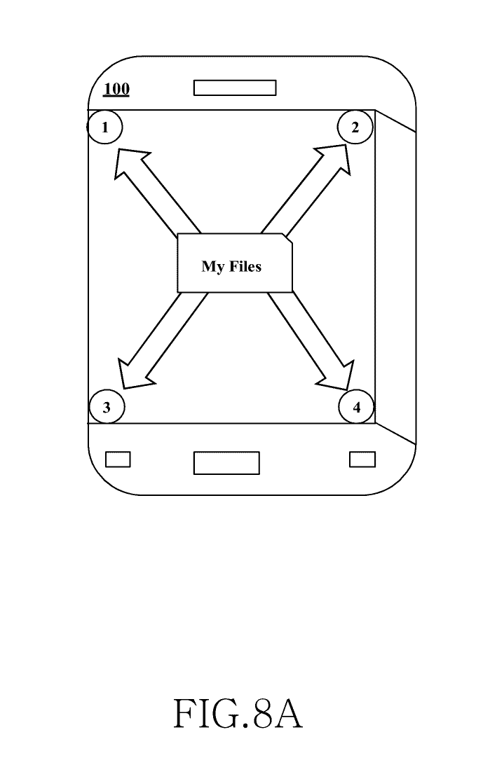

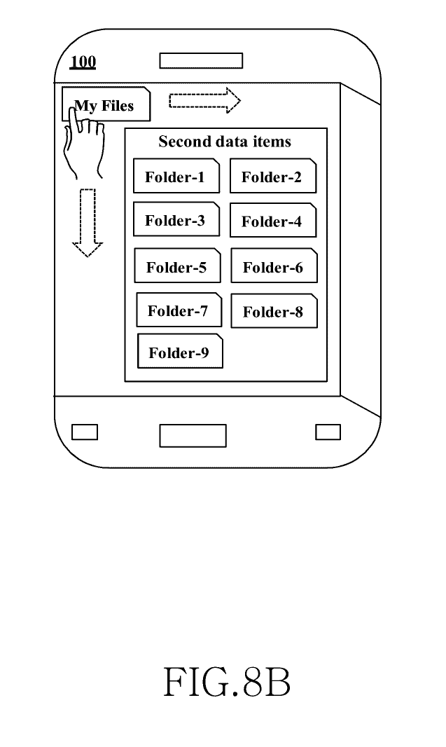

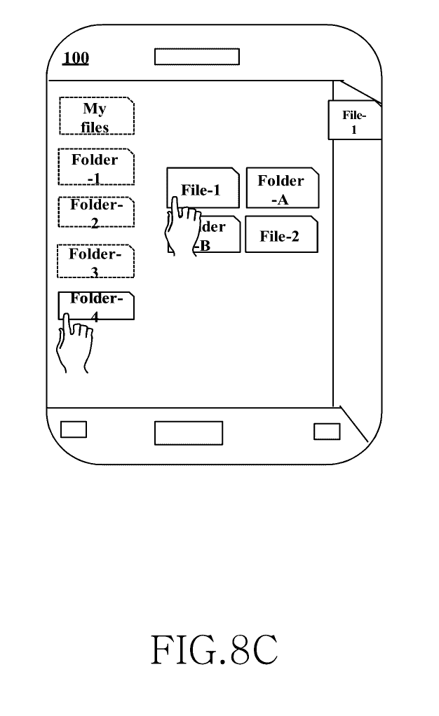

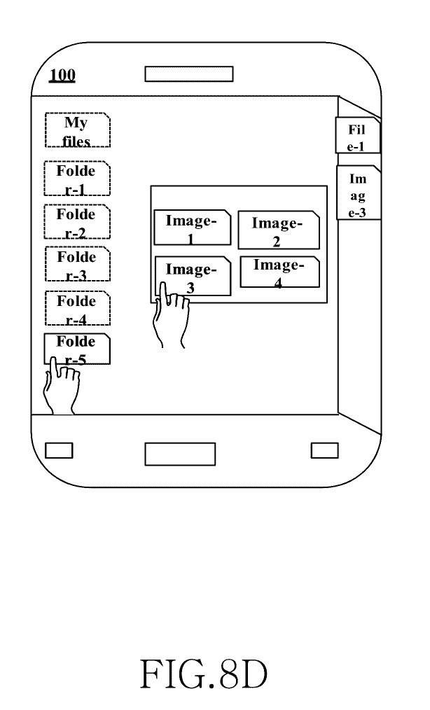

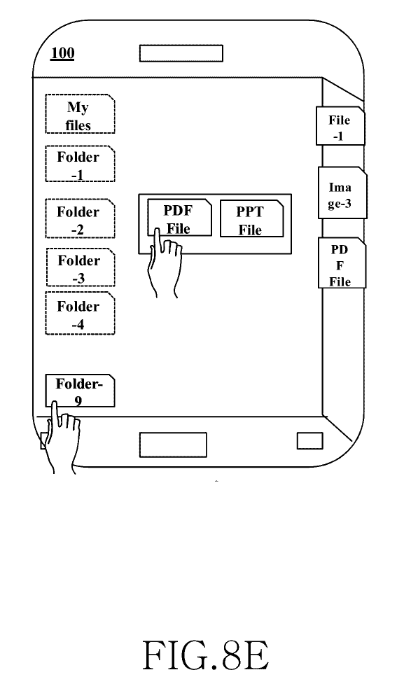

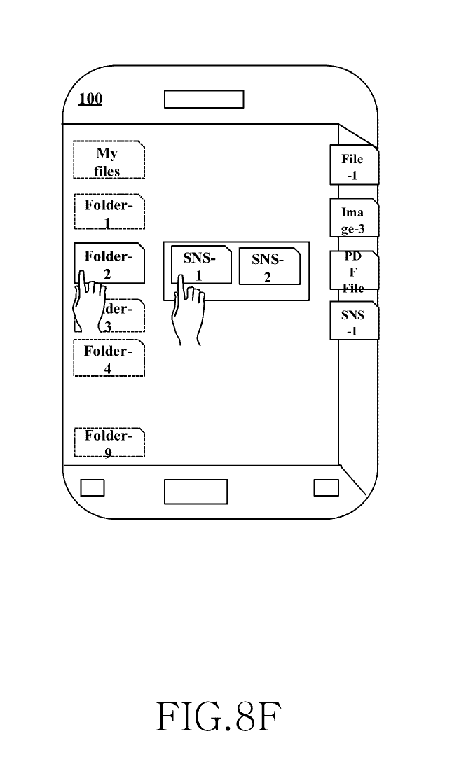

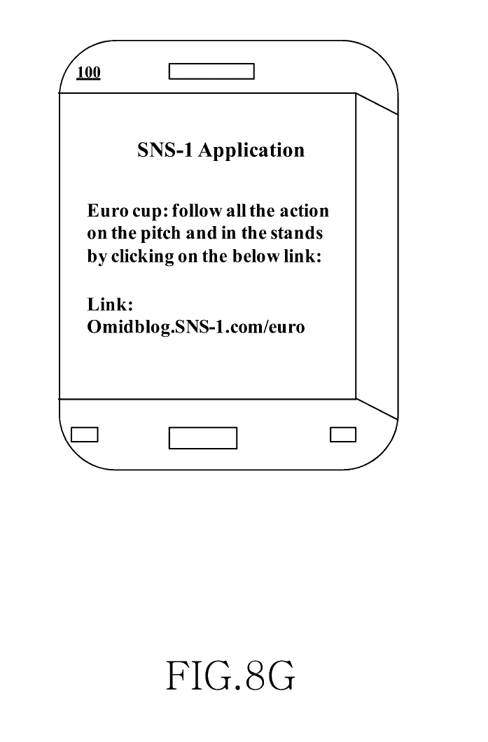

FIGS. 8A to 8G illustrate an example illustration in which the glide motion is performed on the directory displayed on the screen to display selected multiple data items on a screen edge of the electronic device 100, according to an embodiment of the present invention. Initially, the user selects the “My Files” (i.e., directory) which the user intends to browse for selecting multiple data items and display the selected multiple data items on the screen edge of the electronic device 100. After selecting the “My Files” displayed on the home screen of the electronic device 100, the processor unit 104 can be configured to activate the “Glide Screen” and displays “4” Glide zones on the screen of the electronic device 100. The “4” Glide zones are displayed to the user for initiating the navigation to select the multiple data items as shown in the FIG. 8A.

As shown in the FIG. 8B, the user selects the “TOP-LEFT” glide zone (i.e., glide zone-1) where the user performs the long press event (i.e., first gesture) on the selected “My Files icon” for the predefined amount of time (i.e., “HOLD TIMER” period). The “My Files” constitutes the sub-folders, files, or the like (i.e., set of second data items). After detecting the long press event, the processor unit 104 can be configured to cause to display the content (i.e., “Folder-1”, “Folder-2”, “Folder-3”, “Folder-4”, “Folder-5”, “Folder-6”, “Folder-7”, “Folder-8”, and “Folder-9”) of the “My Files”. Further, the user needs to perform the vertically glide motion to navigate through the sub-folders.

As shown in the FIG. 8C, the user performs the vertical glide motion downwards covering the distance of 4 units from the glide zone-1 to glide to the “Folder-4”. After detecting the vertical glide motion, the processor unit 104 can be configured to cause to display the content (i.e., “Word File-1”, “Folder-A”, “Folder-B”, and “Excel File-1”) in the “Folder-4”. The user performs the third gesture to mark the “Word File-1” for future selection. After selecting the “Word File-1”, the processor unit 104 can be configured to hold the “Word File-1” at the screen edge of the electronic device. In an example, the “Word File-1” is transferred to edge of the screen. Further, the user continues to perform the vertical glide motion in the downward direction.

As shown in the FIG. 8D, the user further performs the vertical glide motion downwards covering the distance of 5 units from the glide zone-1 to glide to the “Folder-5”. After detecting the vertical glide motion, the processor unit 104 can be configured to cause to display the content (i.e., “Image-1”, “Image-2”, “Image-3”, and “Image-4”) in the “Folder-5”. The user performs the third gesture to mark the “Image-3” for future selection. After selecting the “Image-3”, the processor unit 104 can be configured to hold the “Image-3” at the edge of the screen. In an example, the “Image-3” is transferred to the edge of the screen of the electronic device 100. Further, the user continues to perform the vertical glide motion in the downward direction.

As shown in the FIG. 8E, the user further performs the vertical glide motion downwards covering the distance of 9 units from the glide zone-1 to glide to the “Folder-9”. After detecting the vertical glide motion, the processor unit 104 can be configured to cause to display the content (i.e., “PDF File” and “PPT File”) in the “Folder-9”. The user performs the third gesture to mark the “PDF File” for future selection. After selecting the “PDF File”, the processor unit 104 can be configured to hold the “PDF File” at the edge of the screen. In an example, the “PDF File” is transferred to the edge of the screen of the electronic device 100.

As shown in the FIG. 8F, the user performs the vertical glide motion upwards to glide to the “Folder-2”. After detecting the vertical glide motion in the upward direction, the processor unit 104 can be configured to cause to display the content (i.e., “SNS-1” and “SNS-2”) in the “Folder-2”. The user performs the third gesture to mark the “SNS-1” for future selection. After selecting the “SNS-1”, the processor unit 104 can be configured to hold the “SNS-1” at the edge of the screen. In an example, the “SNS-1” is transferred to the edge of the screen of the electronic device 100. Further, the user ends the current vertical glide motion over the “My Files” directory and can able to select the “SNS-1” application to be executed from the items displayed in the edge of the screen. The user selects the “SNS-1” application icon. The navigation session is completed and the “SNS-1” application is launched and displayed on the screen of the electronic device 100 as shown in the FIG. 8G.

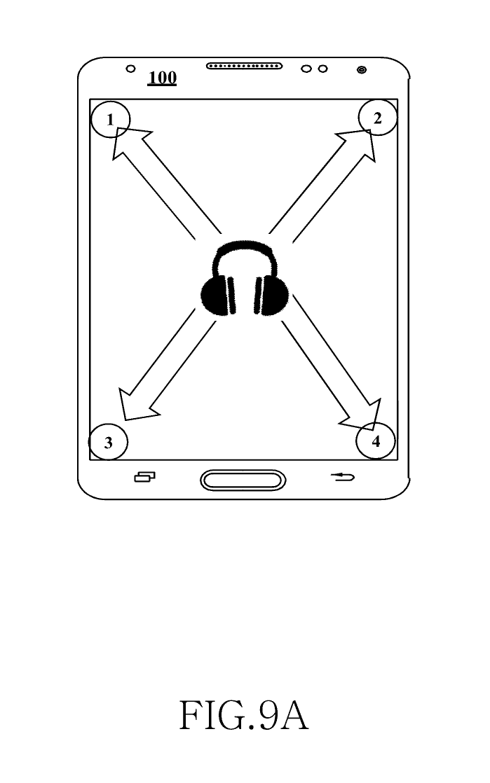

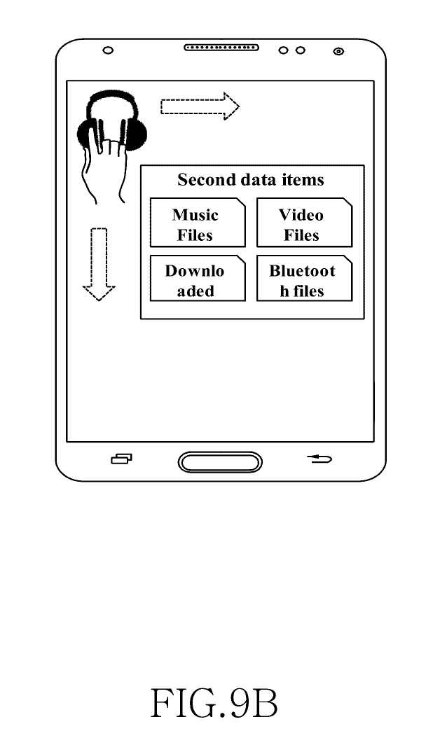

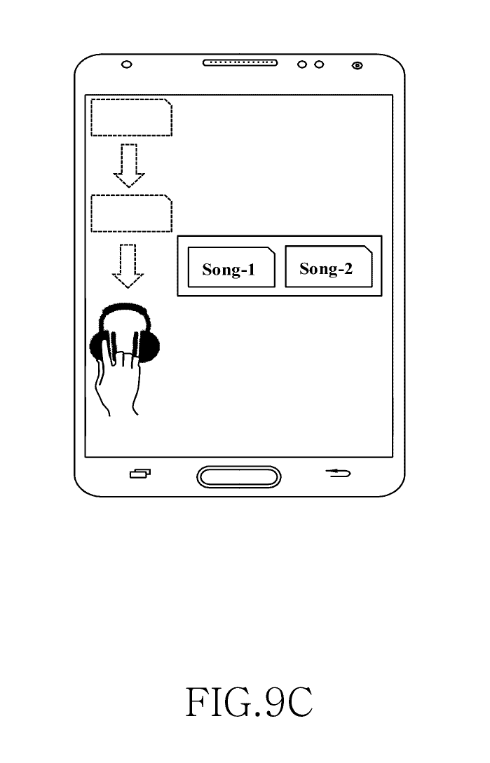

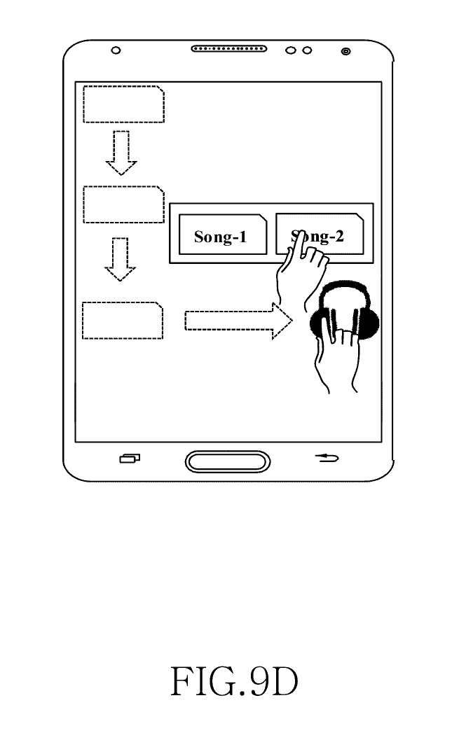

FIGS. 9A to 9D illustrate an example illustration in which the glide motion is performed on the Music icon for context based navigation to select context related content, according to an embodiment of the present invention. Initially, the user selects the “Music Icon” which the user intends to browse for selecting context related data item. After selecting the “Music Icon” displayed on the home screen of the electronic device 100, the processor unit 104 can be configured to activate the “Glide Screen” and displays “4” Glide zones on the screen of the electronic device 100. The “4” Glide zones are displayed to the user for initiating the navigation to select the context related data item as shown in the FIG. 9A.

As shown in the FIG. 9B, the user selects the “TOP-LEFT” glide zone (i.e., glide zone-1) where the user performs the long press event (i.e., first gesture) on the selected “Music Icon” for the predefined amount of time (i.e., “HOLD TIMER” period). The “Music Icon”. After detecting the long press event, the processor unit 104 can be configured to cause to display the context related content based on the “Music Icon” (i.e., “Music Files”, “Video Files”, “Download Files”, and “Bluetooth Files”) related to the context of the “Music Icon”. Here, only the content or the sub-directories which contains the content matching the context are displayed. Further, the context is “Music” as the “Music Icon” is selected by the user; only the audio and video files match the context and are displayed to the user on the screen of the electronic device 100. Further, the user needs to perform the vertical glide motion to navigate through the sub-folders.

As shown in the FIG. 9C, the user performs the vertical glide motion downwards covering the distance of 3 units from the glide zone-1 to glide to the “Downloaded” folder and finds the music file which the user is intended to play is located. In the “Downloaded” folder, only the content match with the current context is displayed on the screen of the electronic device 100. So, only the music files (i.e., “Song-1” and “Song-2”) are displayed and not other files which are available in the “Downloaded” folder.

As shown in the FIG. 9D, the user intends to play the “Song-2”; and performs the horizontal glide motion to select and execute the “Song-2”. The current selection is always highlighted and is mapped with the horizontal glide motion. Further, the user ends the navigation session and the selected “Song-2” is executed in the music player.

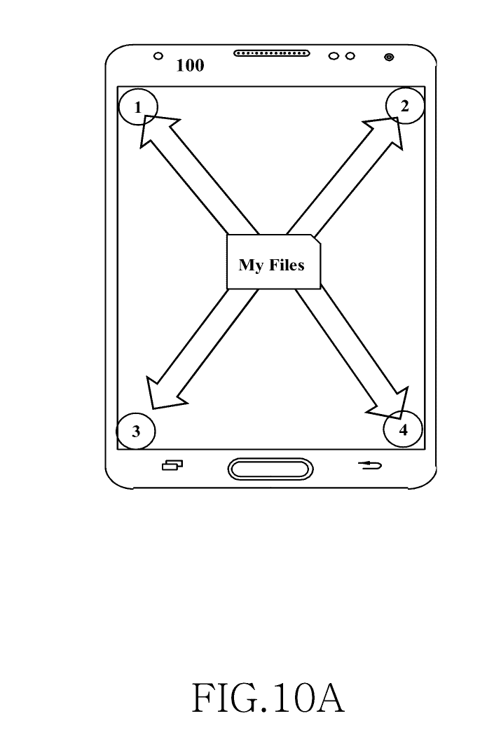

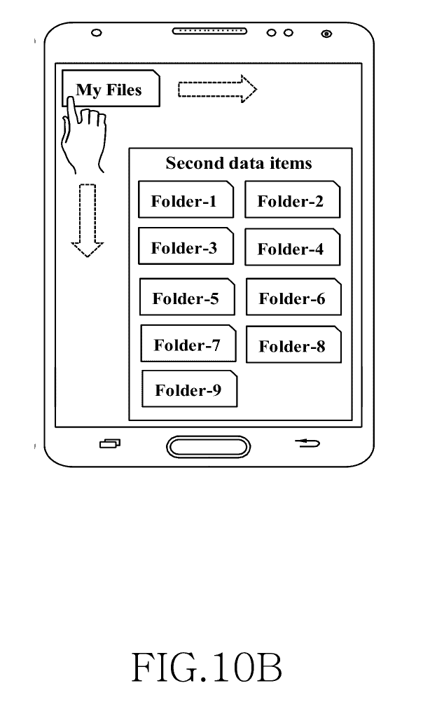

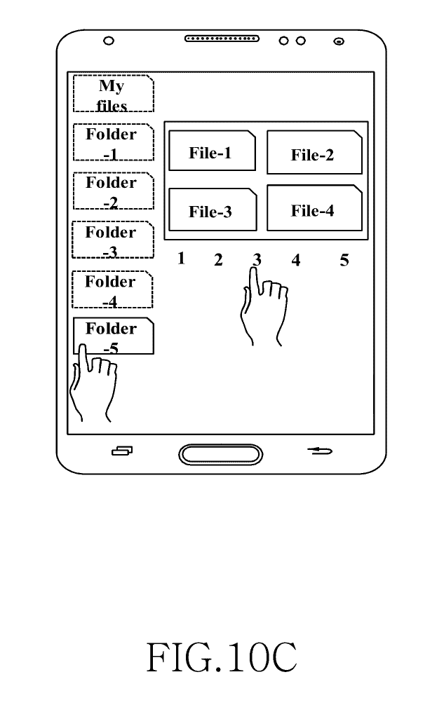

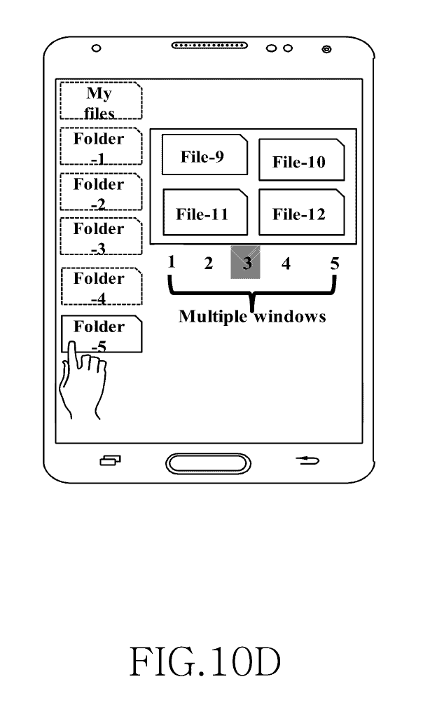

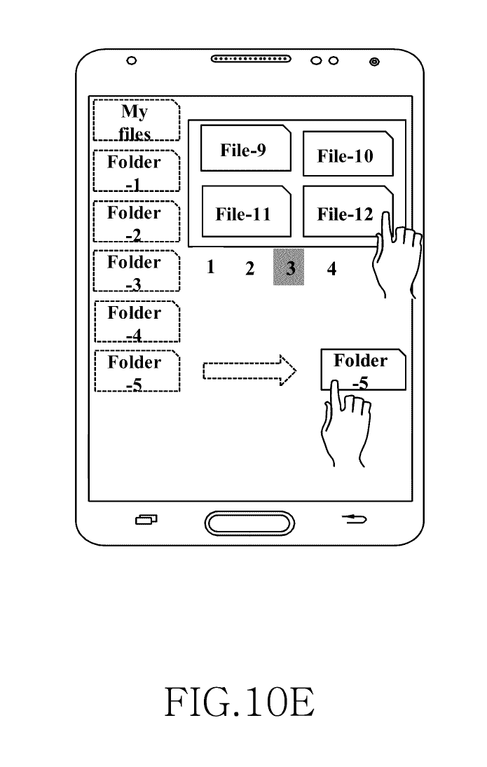

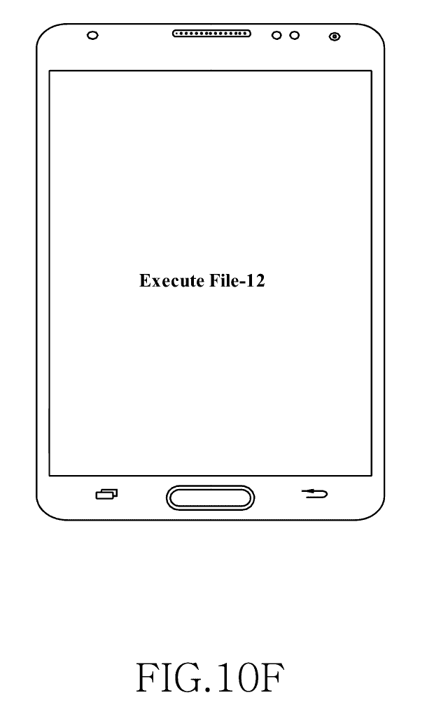

FIGS. 10A to 10F illustrate an example illustration in which the “Glide Motion” is performed on the directory displayed on the screen of the electronic device 100 to select and execute a “File-12”, according to an embodiment of the present invention. Initially, the user selects the “My Files” (i.e., directory) which the user intends to browse for selecting and executing “File-12”. After selecting the “My Files” displayed on the home screen of the electronic device 100, the processor unit 104 can be configured to activate the “Glide Screen” and displays “4” Glide zones on the screen of the electronic device 100. The “4” Glide zones are displayed to the user for initiating the navigation to select the multiple data items as shown in the FIG. 10A.

As shown in the FIG. 10B, the user selects the “TOP-LEFT” glide zone (i.e., glide zone-1) where the user performs the long press event (i.e., first gesture) on the selected “My Files icon” for the predefined amount of time (i.e., “HOLD TIMER” period). The “My Files” constitutes the sub-folders, files, or the like (i.e., set of second data items). After detecting the long press event, the processor unit 104 can be configured to cause to display the content (i.e., “Folder-1”, “Folder-2”, “Folder-3”, “Folder-4”, “Folder-5”, “Folder-6”, “Folder-7”, “Folder-8”, and “Folder-9”) of the “My Files”. Further, the user needs to perform the vertically glide motion to navigate through the sub-folders.

As shown in the FIG. 10C, the user performs the vertical glide motion downwards covering the distance of 5 units from the glide zone-1 to glide to the “Folder-5”. After detecting the vertical glide motion, the processor unit 104 can be configured to cause to display the content (i.e., “File-1”, “File-2”, “File-3”, and “File-4”) in the “Folder-5”. Along with the content in the “Folder-5”, multiple windows are displayed to the user displaying the contents of the current directory. The user performs the third gesture to select the window “3”.

As shown in the FIG. 10D, the window “3” (i.e., current selected window) is highlighted. Further, the processor unit 104 can be configured to cause to display the content (i.e., “File-9”, “File-10”, “File-11”, and “File-12”) of the window “3”. As the user intended file is available in the window “3” of the “Folder-5”, the user needs to perform the horizontal glide motion for selecting the “File-12”.

As shown in the FIG. 10E, the user performs the horizontal glide motion covering the distance of “4” units to highlight the “File-12”. The user ends the navigation and selects the “File-12” to be executed. Further, as shown in the FIG. 10F, the processor unit 104 can be configured to display the executed “File-12” on the screen of the electronic device 100.

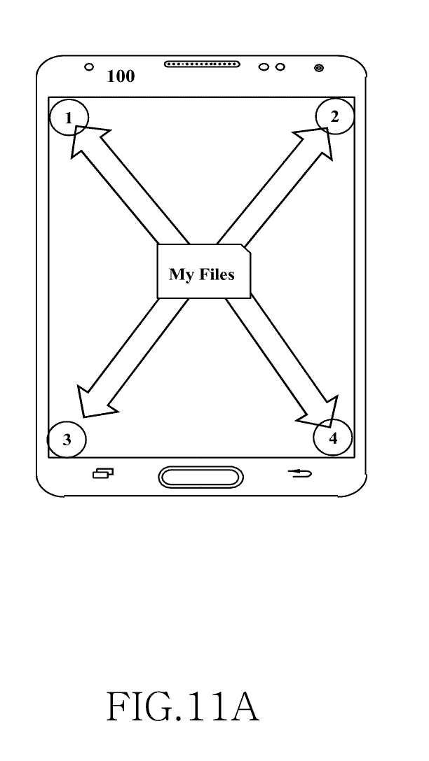

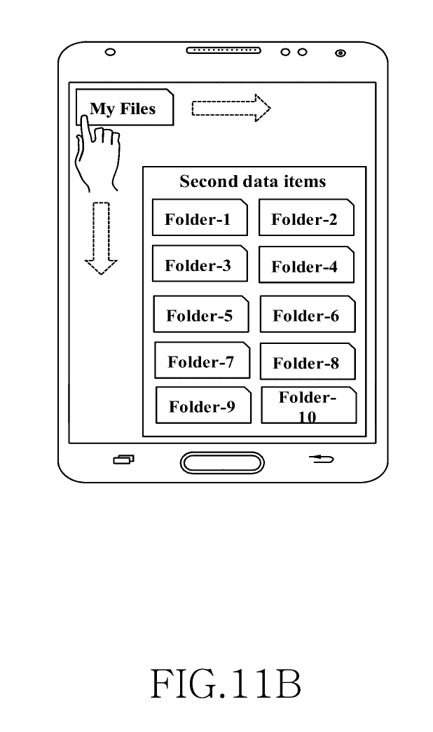

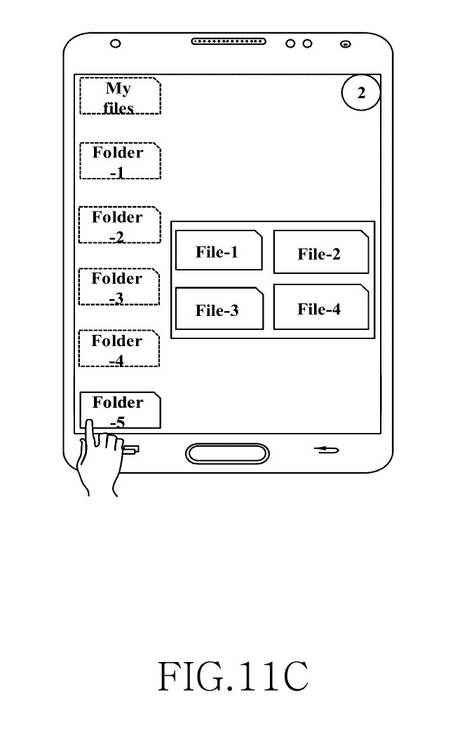

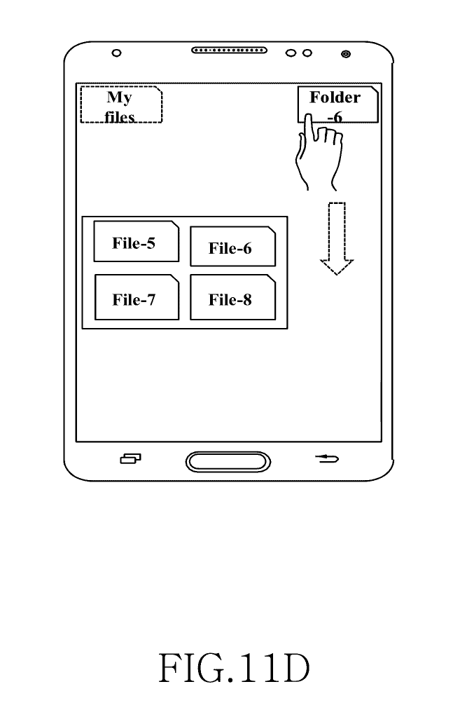

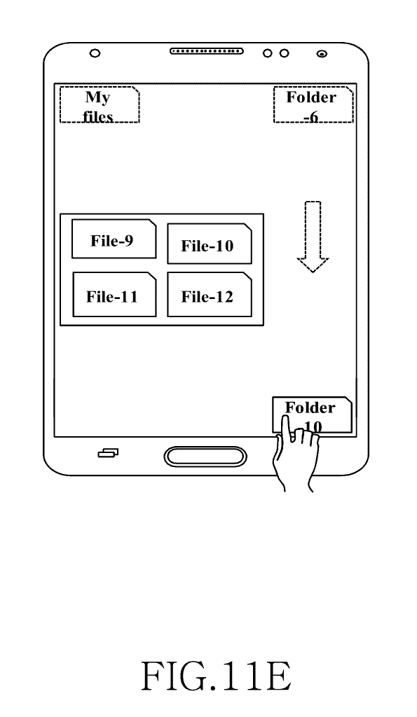

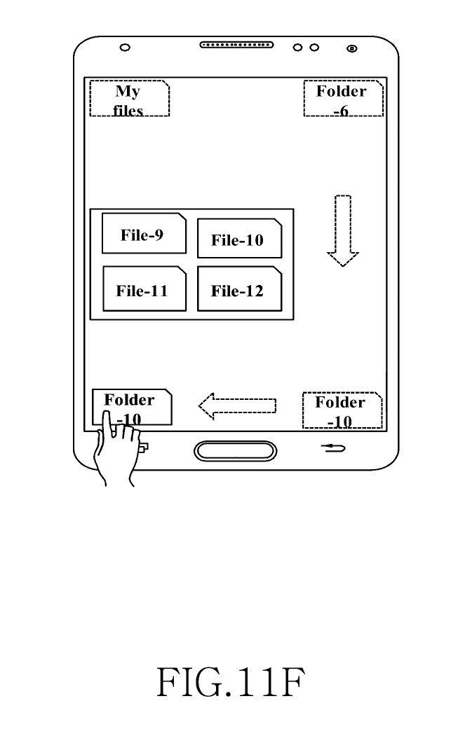

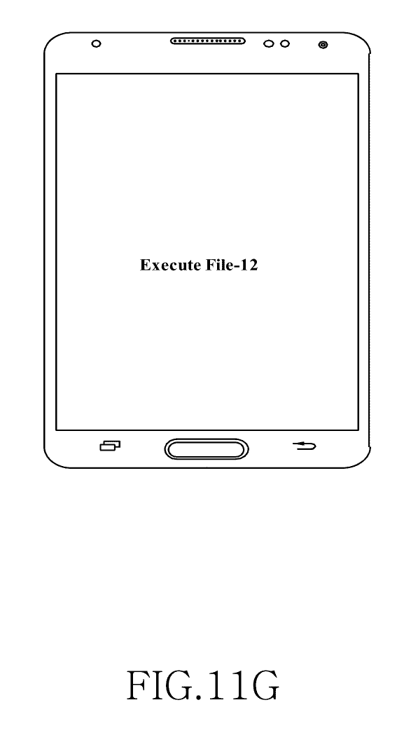

FIGS. 11A to 11G illustrate an example illustration in which the user is provided with an option to toggle navigation side to select and execute a “File-12”, according to an embodiment of the present invention. Initially, the user selects the “My Files” (i.e., directory) which the user intends to browse for selecting and executing “File-12”. After selecting the “My Files” displayed on the home screen of the electronic device 100, the processor unit 104 can be configured to activate the “Glide Screen” and displays “4” Glide zones on the screen of the electronic device 100. The “4” Glide zones are displayed to the user for initiating the navigation to select the data item as shown in the FIG. 11A.

As shown in the FIG. 11B, the user selects the “TOP-LEFT” glide zone (i.e., glide zone-1) where the user performs the long press event (i.e., first gesture) on the selected “My Files icon” for the predefined amount of time (i.e., “HOLD TIMER” period). The “My Files” constitutes the sub-folders, files, or the like (i.e., set of second data items). After detecting the long press event, the processor unit 104 can be configured to cause to display the content (i.e., “Folder-1”, “Folder-2”, “Folder-3”, “Folder-4”, “Folder-5”, “Folder-6”, “Folder-7”, “Folder-8”, “Folder-9”, and “Folder-10”) of the “My Files”. Further, the user needs to perform the vertically glide motion to navigate through the sub-folders.

As shown in the FIG. 11C, the user performs the vertical glide motion downwards covering the distance of 5 units from the glide zone-1 to glide to the “Folder-5”. After detecting the vertical glide motion, the processor unit 104 can be configured to cause to display the content (i.e., “File-1”, “File-2”, “File-3”, and “File-4”) in the “Folder-5”. As the glide motion has reached the maximum threshold depth during the vertical navigation, the user can move to the toggle zone (i.e., glide zone-2) to continue performing vertical glide motion to navigate through the sub-directories.

As shown in the FIG. 11D, the user selects the “TOP-RIGHT” glide zone (i.e., glide zone-2) where the user performs the long press event on the selected “Folder-6 Icon” for the predefined amount of time (i.e., “HOLD TIMER” period). After detecting the long press event, the processor unit 104 can be configured to cause to display the content (i.e., “File-5”, “File-6”, “File-7”, and “File-8”) of the “Folder-6”. Further, the user needs to perform the vertically glide motion to navigate through the remaining sub-folders in the “My Folder”.

As shown in the FIG. 11E, the user performs the vertical glide motion downwards covering the distance of 5 units from the glide zone-1 to glide to the “Folder-10”. After detecting the vertical glide motion, the processor unit 104 can be configured to cause to display the content (i.e., “File-9”, “File-10”, “File-11”, and “File-12”) in the “Folder-10”. As the “File-12” which is user intended file is available in the displayed content, the user needs to navigate horizontally to select the “File-12”.

As shown in the FIG. 11F, the user performs the horizontal glide motion covering the distance. The horizontal axis is scaled as per the available executable data items in the “Folder-10”. The user covers the distance of 4 units and the corresponding “Word File-12” is highlighted. The user ends the navigation and selects the “File-12” to be executed. Further, as shown in the FIG. 11G, the processor unit 104 can be configured to display the executed “File-12” on the screen of the electronic device 100.

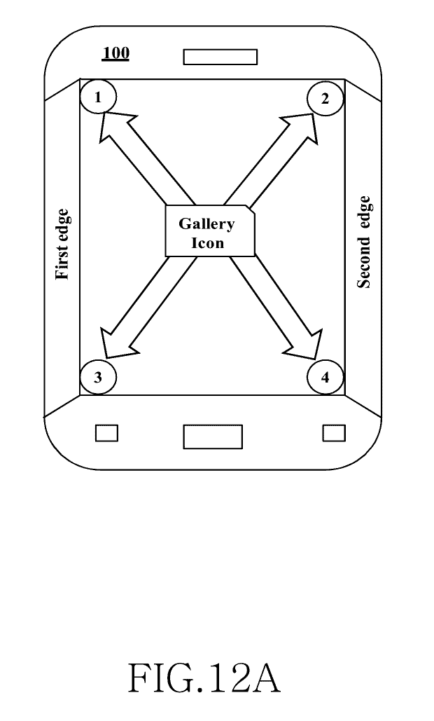

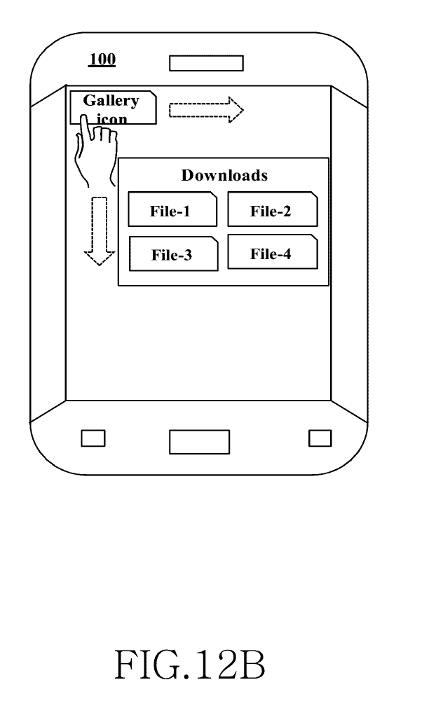

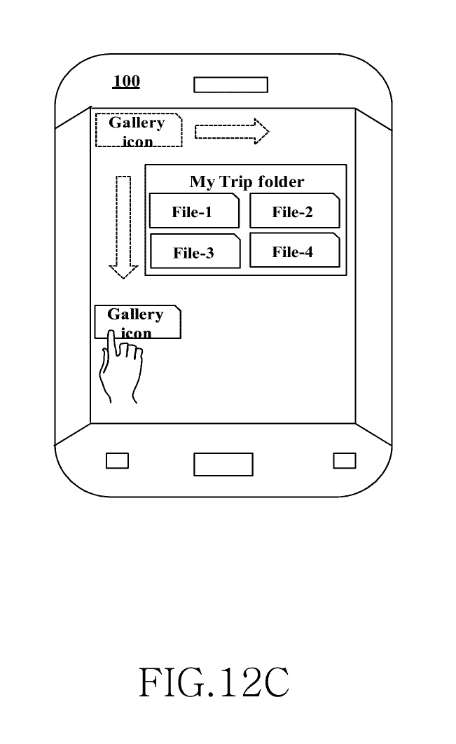

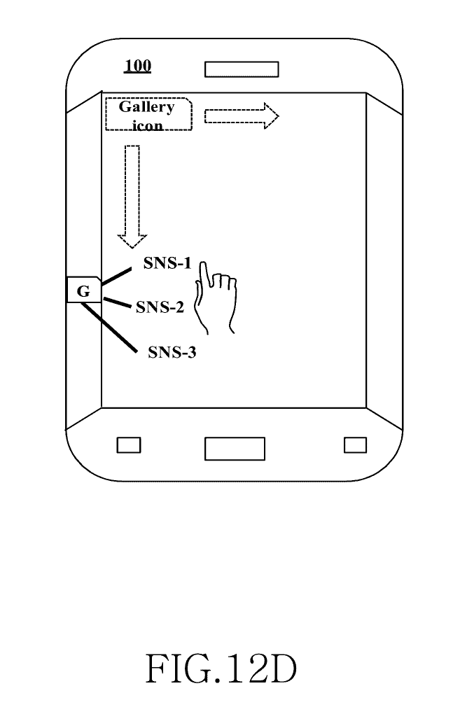

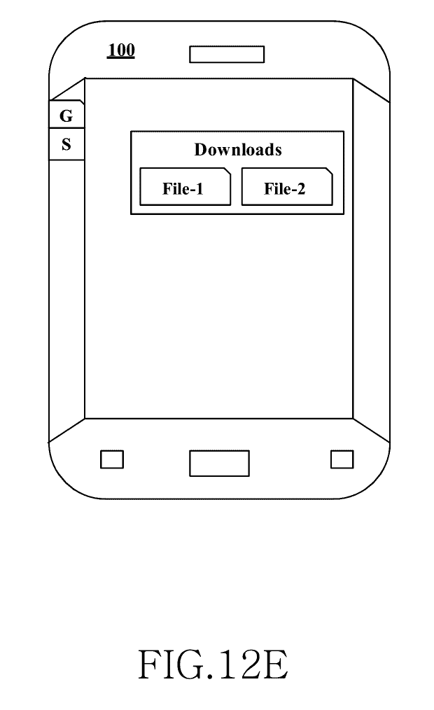

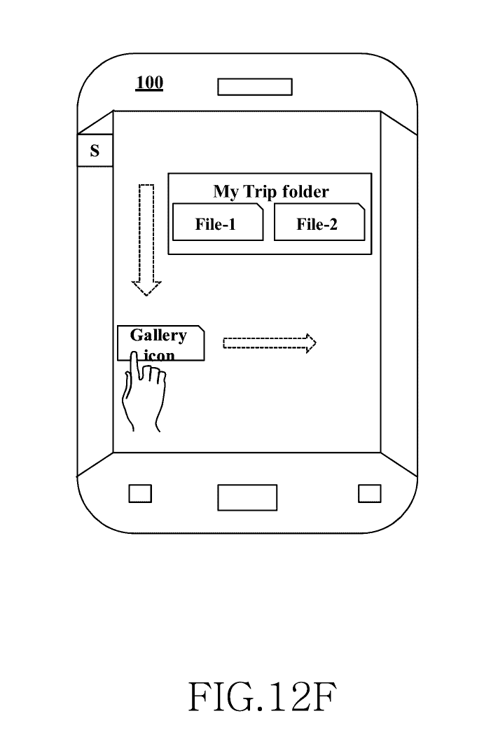

FIGS. 12A to 12F illustrate an example illustration in which the “Glide Motion” is performed on the “Gallery Icon” displayed on the screen of the electronic device 100 for providing the user with options to input multiple contexts during the ongoing context based navigation, according to an embodiment of the present invention. Initially, the user selects the “Gallery Icon” which the user intends to browse for selecting the context based data items related to the “Gallery Icon”. After selecting the “Gallery Icon” displayed on the home screen of the electronic device 100, the processor unit 104 can be configured to activate the “Glide Screen” and displays “4” Glide zones on the screen of the electronic device 100. The “4” Glide zones are displayed to the user for initiating the navigation to select the document as shown in the FIG. 12A.

As shown in the FIG. 12B, the user selects the “TOP-LEFT” glide zone (i.e., glide zone-1) where the user performs the long press event on the selected “Gallery Icon” for the predefined amount of time (i.e., “HOLD TIMER” period). The “Gallery” constitutes the sub-folders, files, or the like (i.e., set of second data items). After detecting the long press event, the processor unit 104 can be configured to cause to display the content of the “Downloads”.

As shown in the FIG. 12C, the user performs the vertical glide motion downwards covering the distance from the “glide zone-1”. After detecting the vertical glide motion, the processor unit 104 can be configured to cause to display the content in the “My Trip” folder.

As shown in the FIG. 12D, the user currently navigating using the gallery context decides to add another relevant context. The user performs the third gesture on the “Gallery Icon”. After detecting the third gesture, the processor unit 104 can be configured to attach (or hinge) the “Gallery Icon” (G) to the edge of the screen. Further, after attaching the “Gallery Icon” (G) to the edge of the screen, all the related applications (i.e., SNS-1, SNS-2, and SNS-2) similar to the context are displayed on the screen of the electronic device 100.

As shown in the FIG. 12E, the user selects the SNS-1 (S); and the SNS-1 (S) is displayed by hinging with the “Gallery Icon”. The processor unit 104 can be configured to display only the content which matches the context of the “Gallery Icon” and the SNS-1. Further, the user can perform horizontal glide motion for selecting the file as shown in the FIG. 12F.

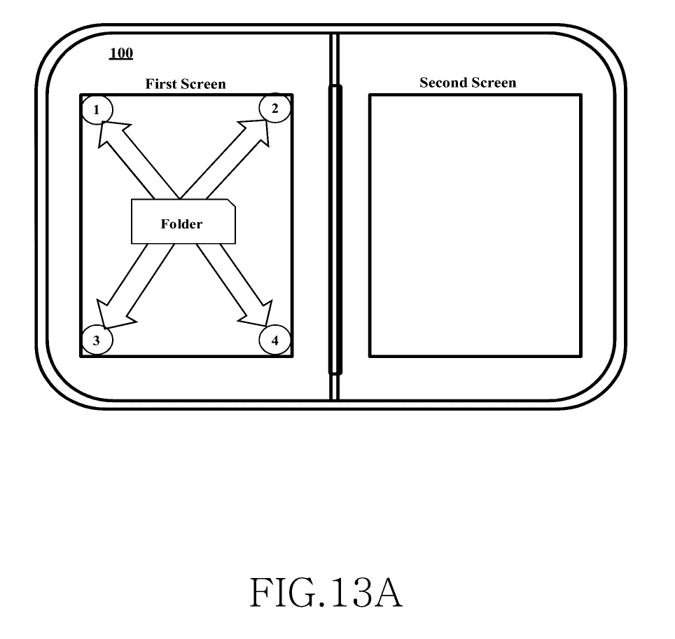

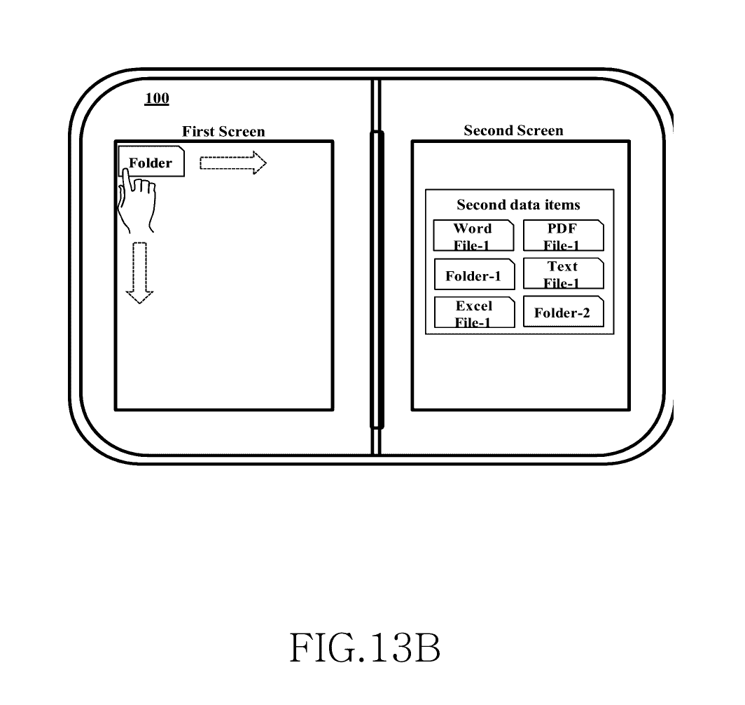

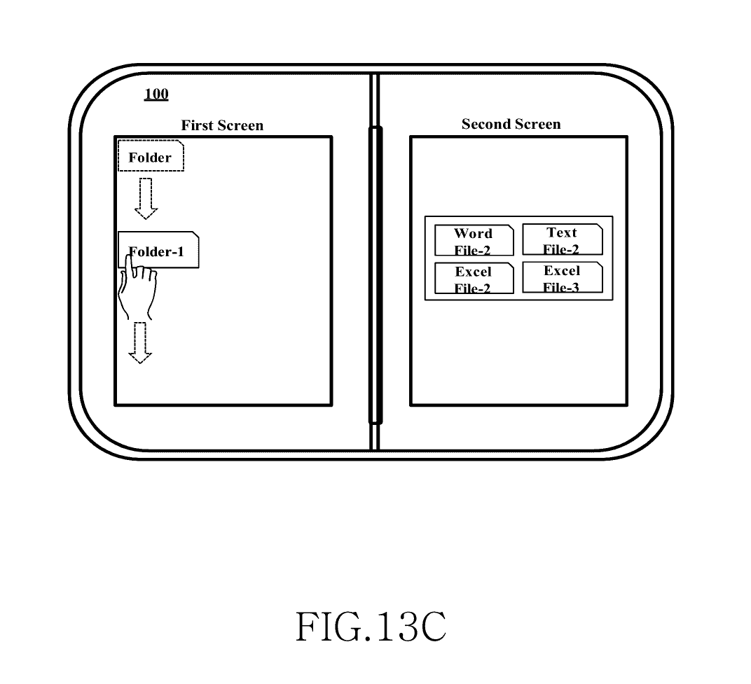

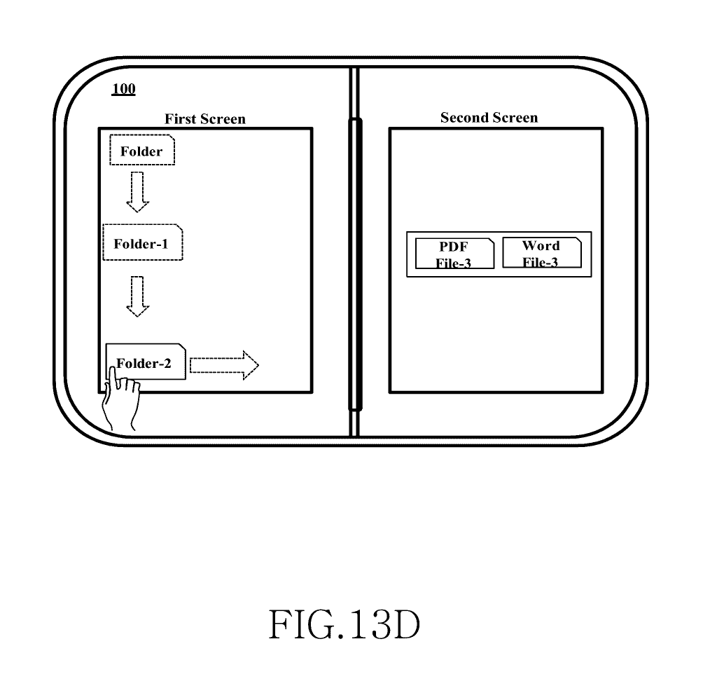

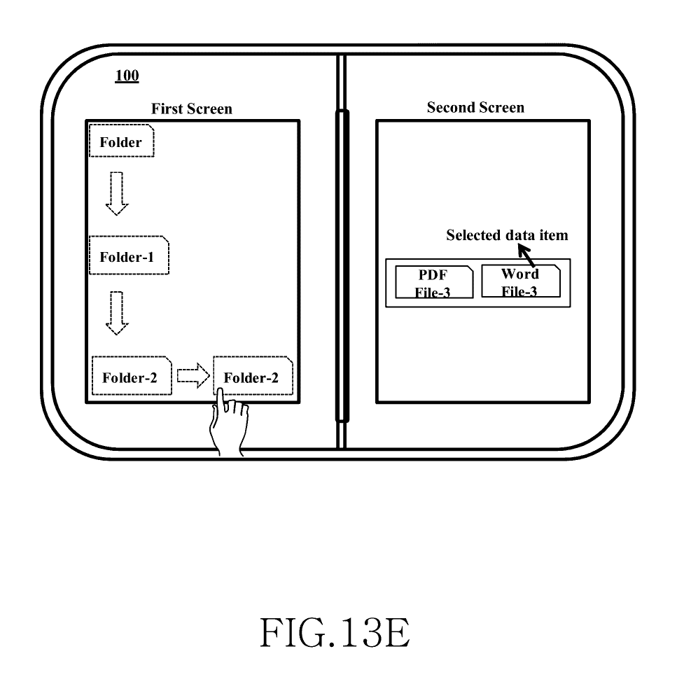

FIGS. 13A to 13E illustrate an example illustration in which the “Glide motion” is performed on the directory displayed on the first screen of the electronic device 100, according to an embodiment of the present invention. The electronic device 100 is a multi-screen device including the first screen and the second screen, where the “Glide motion” is performed on the first screen and the contents are displayed on the second screen.

As shown in the FIG. 13A, initially, the user selects the “Folder” (i.e., directory) which the user intends to browse for selecting the “Word File-3” (i.e., data item) in the “Folder”. After selecting the “Folder” displayed on the home screen of the electronic device 100, the processor unit 104 can be configured to activate the “Glide Screen” and displays “4” Glide zones on the first screen of the electronic device 100. The “4” Glide zones are displayed to the user for initiating the navigation to select the document as shown in the FIG. 13A.

As shown in the FIG. 13B, the user selects the “TOP-LEFT” glide zone (i.e., glide zone-1) on the first screen where the user performs the long press event (i.e., first gesture) on the selected “Folder icon” for the predefined amount of time (i.e., “HOLD TIMER” period). The “Folder” constitutes the sub-folders, files, or the like (i.e., set of second data items). After detecting the long press event, the processor unit 104 can be configured to cause to display the content (i.e., “Word File-1”, “PDF File-1”, “Folder-1”, “Text File-1”, “Excel File-1”, and “Folder-2”) of the “Folder” on the second screen. As the “Word File-3” which is user intended file is not available in displayed content on the second screen, the user further needs to navigate vertically down on the first screen to browse the content in the sub-folders (i.e., “Folder-1”).

As shown the FIG. 13C, the user performs the vertical glide motion (i.e., second gesture) downwards covering the distance from the “Folder” on the first screen. After detecting the vertical glide motion on the first screen, the processor unit 104 can be configured to cause to display the content (i.e., “Word File-2”, “Text File-2”, “Excel File-2”, and “Excel File-3”) on the second screen. As the “Word File-3” which is user intended file is not available in displayed content on the second screen, the user further needs to navigate vertically down on the first screen to browse the content (i.e., “Folder-2”).

Further, as shown in the FIG. 13D, the user further performs the vertical glide motion downwards covering the distance from the “Folder-1” on the first screen. After detecting the vertical glide motion, the processor unit 104 can be configured to display the content (i.e., “PDF File-3 and “Word File-3”) on the second screen of the electronic device 100. As the user intended file is available in the sub-folder “Folder-2”, the user performs the long press event on the “Folder-2” displayed on the first screen for the “HOLD-TIMER” to expire. Further, the user needs to perform the horizontal glide motion for selection the “Word File-3”.

Further, as shown in the FIG. 13E, the user performs the horizontal glide motion covering the distance to highlight the “Word File-3” displayed on the second screen. The user ends the navigation and selects the “Word File-3” to be executed. The processor unit 104 can be configured to display the executed “Word File-3” on the second screen of the electronic device 100.

Although the above description is described in conjunction with the electronic device 100 for selecting the data item from the directory but it is to be understood that other embodiments are not limited thereon. The proposed method described herein can also be implemented in any electronic device without departing from the scope of the invention. For example, the proposed method described herein can also be implemented in the electronic device(s) having edges bent at an angle (i.e., chamfered). In another example, the electronic device having a flat screen with edges defined by the logical pattern of the screen may also implement the gestures as described herein.

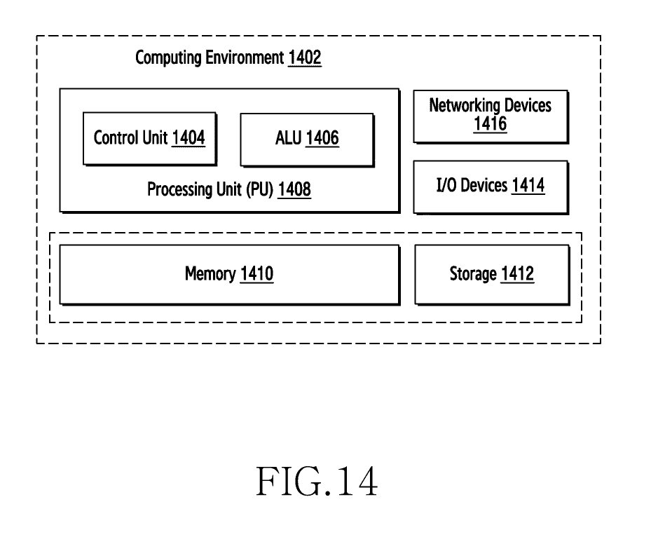

FIG. 14 illustrates a computing environment implementing the method for selecting the data item from the directory in the electronic device 100, according to an embodiment of the present invention. As depicted in the figure, the computing environment 1402 comprises at least one processing unit 1408 that is equipped with a control unit 1404 and an Arithmetic Logic Unit (ALU) 1406, a memory 1410, a storage unit 1412, plurality of networking devices 1416 and a plurality Input output (I/O) devices 1414. The processing unit 1408 is responsible for processing the instructions of the technique. The processing unit 1408 receives commands from the control unit in order to perform its processing. Further, any logical and arithmetic operations involved in the execution of the instructions are computed with the help of the ALU 1406.

The overall computing environment 1402 can be composed of multiple homogeneous and/or heterogeneous cores, multiple CPUs of different kinds, special media and other accelerators. The processing unit 1408 is responsible for processing the instructions of the technique. Further, the plurality of processing units 1408 may be located on a single chip or over multiple chips.

The technique comprising of instructions and codes required for the implementation are stored in either the memory unit 1410 or the storage 1412 or both. At the time of execution, the instructions may be fetched from the corresponding memory 1410 or storage 1412, and executed by the processing unit 1408.

In case of any hardware implementations various networking devices 1416 or external I/O devices 1414 may be connected to the computing environment to support the implementation through the networking unit and the I/O device unit.

The embodiments disclosed herein can be implemented through at least one software program running on at least one hardware device and performing network management functions to control the elements. The elements shown in the FIGS. 1 through 14 include blocks which can be at least one of a hardware device, or a combination of hardware device and software module.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments of the present invention.

1. A method for operating an electronic device, the method comprising:
detecting a first touch input dragging a first object for a folder to a predetermined region of a screen of the electronic device; and displaying at least one second object for at least one item which is included in the folder on the electronic device based on the first touch input;
detecting a second touch input to select one object among the at least one second object; and
performing an item corresponding to the selected object.

2. The method of claim 1, further comprising:
detecting a third touch input dragging a predetermined distance from the first object; and
displaying at least one third object for at least one item which is included in one of the at least one second object on the electronic device based on the third touch input.

3. The method of claim 1, further comprising:
storing the selected object by replicating the selected object at a predetermined storage space of the electronic device.

4. The method of claim 1, wherein the at least one second object comprises at least one sub-object of the first object.

5. The method of claim 2, further comprising:
detecting a forth touch input to select another object among the at least one third object; and
performing an item corresponding to the selected another object.

6. The method of claim 2, further comprising:
detecting a forth third touch input dragging another predetermined distance from the first object; and
displaying at least one forth object for at least another item which is included in one of the at least one second object on the electronic device based on the forth touch input.

7. The method of claim 2, wherein the predetermined distance comprises one of a predetermined vertical distance and a predetermined horizontal distance.

8. The method of claim 1, wherein the first input and second input are consecutive by maintaining a touch-on state for a screen of the electronic device.

9. The method of claim 1, wherein the first object is displayed on a first screen of the electronic device, and
wherein the at least one second object is displayed on a second screen of the electronic device.

10. The method of claim 1, wherein the first object is displayed on a first portion of a screen of the electronic device, and
wherein the at least one second object is displayed on a second portion of the screen of the electronic device,
further comprising:
displaying the selected object on another screen of the electronic device.

11. An electronic device comprising:
a controller configured to:
detect a first touch input dragging a first object for a folder to a predetermined region of a screen of the electronic device;
display at least one second object for at least one item which is included in the folder on the electronic device based on the first touch input;
detect a second touch input to select one object among the at least one second object; and
perform an item corresponding to the selected object.

12. The electronic device of claim 11, wherein the controller is further configured to:
detect a third touch input dragging a predetermined distance from the first object; and
display at least one third object for at least one item which is included in one of the at least one second object on the electronic device based on the third touch input.

13. The electronic device of claim 11, wherein the controller is further configured to:
store the selected object by replicating the selected object at predetermined storage space.

14. The electronic device of claim 11, wherein the at least one second object comprise at least one sub-object of the first object.

15. The electronic device of claim 12, wherein the controller is further configured to:
detect a forth touch input to select another object among the at least one third object; and
perform an item corresponding to the selected another object.

16. The electronic device of claim 12, wherein the controller is further configured to:
detect a forth touch input dragging another predetermined distance from the first object; and
display at least one forth object for at least another item which is included in one of the at least one second object on the electronic device based on the forth touch input.

17. The electronic device of claim 12, wherein the predetermined distance comprises one of a predetermined vertical distance and a predetermined horizontal distance.

18. The electronic device of claim 11, wherein the first input and second input are consecutive by maintaining a touch-on state for a screen of the electronic device.

19. The electronic device of claim 11, wherein the first object is displayed on a first screen of the electronic device, and
wherein the at least one second object is displayed on a second screen of the electronic device.

20. The electronic device of claim 11, wherein the first object is displayed on a first portion of a screen of the electronic device,
wherein the at least one second object is displayed on a second portion of the screen of the electronic device, and
wherein the controller is further configured to:
display the selected object on another screen of the electronic device.
